(19) United States
(12) Patent Application Publication
(10) Pub. No.: US 2026/0164227 A1
(43) Pub. Date: Jun. 11, 2026

(54) DATA TRANSMISSION METHOD AND APPARATUS

(71) Applicant: HUAWEI TECHNOLOGIES CO., LTD., Shenzhen (CN)

(72) Inventors: Huanhuan Huang, Shanghai (CN); Chenghui Peng, Shanghai (CN); Jun Wang, Shanghai (CN); Zhe Liu, Shanghai (CN); Fei Wang, Shanghai (CN)

(73) Assignee: HUAWEI TECHNOLOGIES CO., LTD., Shenzhen (CN)

(21) Appl. No.: 19/456,688

(22) Filed: Jan. 22, 2026

Related U.S. Application Data
(63) Continuation of application No. PCT/CN2023/108932, filed on Jul. 24, 2023.

(51) Int. Cl. H04W 8/14

(52) U.S. Cl. CPC H04W 8/14

(57) ABSTRACT

Embodiments of this application provide a data transmission method and an apparatus. The method includes: An access network device receives first data from a terminal device on a first data bearer, and the access network device sends the first data to a task processing function TPF or a user plane function UPF based on the first data bearer or the first data.

### CROSS-REFERENCE TO RELATED APPLICATIONS

This is a continuation of International Patent Application No. PCT/CN2023/108932, filed on Jul. 24, 2023, the disclosure of which is hereby incorporated by reference in its entirety.

### TECHNICAL FIELD

Embodiments of this application relate to the communication field, and more specifically, to a data transmission method and an apparatus.

### BACKGROUND

In a 5th generation (5G) communication system, transmission of service data is performed between a terminal device and a user plane function (UPF) by establishing a protocol data unit (PDU) session. To effectively enable anything as a service (XaaS) in a future communication system, a concept of “task” is introduced in a 6th generation (6G) communication system, and transmission of task data is performed between the terminal device and a task processing function (TPF) by using an established task session. Usually, the terminal device may not only need to send the service data to the UPF but also need to send the task data to the TPF. However, when receiving data of the terminal device, a base station cannot learn how to forward the data.

### SUMMARY

Embodiments of this application provide a data transmission method and an apparatus, so that a base station can learn how to forward data that is from a terminal device, thereby improving communication efficiency.

According to a first aspect, a data transmission method is provided. The method may be performed by an access network device, or may be performed by a chip or a circuit disposed in the access network device. This is not limited in this application.

The method includes: An access network device receives first data from a terminal device on a first data bearer; and the access network device sends the first data to a TPF based on the first data bearer or the first data, where the TPF is configured to exchange data of a task with the terminal device.

The task includes a process of implementing a service objective based on collaboration of heterogeneous resources.

The heterogeneous resource may be understood as a resource including at least one of computing, intelligence, data, and sensing.

The service objective may include at least one of services such as computing, data, trustworthiness, intelligence, and sensing.

Specifically, the access network device may be any device that has a function of providing access to a communication network for authorized users in a specific region. This is not limited in this application. For example, the access network device may be a gNB in a 5G network, or may have a hierarchical RAN architecture including an sNode and a cNode in a 6G network.

According to the foregoing method, the access network device can learn of data that needs to be forwarded to the TPF, thereby improving communication efficiency.

In some embodiments, the foregoing method further includes: The access network device sends first information to the terminal device, where the first information indicates that the first data bearer is used for transmission of data between the terminal device and the TPF; and the access network device sends the first data to the TPF based on the first data bearer.

Specifically, the first data bearer may be a data bearer newly defined by the access network device. For example, if 10 data radio bearers (DRBs) are currently established, the access network device may define at least one DRB in the 10 DRBs as the first data bearer, and indicate the first data bearer to the terminal device.

Specifically, the foregoing method is applicable to a scenario in which there is one TPF, and is also applicable to a scenario in which there are a plurality of TPFs. The plurality of TPFs in the scenario in which there are a plurality of TPFs respectively perform transmission of data by using different data bearers. For example, the terminal device exchanges data of a task with a TPF #1, and the first data bearer is used for transmission of data between the terminal device and the TPF #1. Alternatively, the terminal device exchanges data of a task #1 with a TPF #1, the terminal device exchanges data of a task #2 with a TPF #2, and the terminal device exchanges data of a task #3 with a TPF #3, where the first data bearer includes a data bearer #1, a data bearer #2, and a data bearer #3, the data bearer #1 is used for transmission of data between the terminal device and the TPF #1, the data bearer #2 is used for transmission of data between the terminal device and the TPF #2, and the data bearer #3 is used for transmission of data between the terminal device and the TPF #3.

According to the foregoing method, based on a bearer for receiving data, the access network device can learn that data is to be forwarded to a TPF and learn of the specific TPF to which the data is to be forwarded, thereby improving communication efficiency.

In some embodiments, when a plurality of TPFs exchange data of a plurality of tasks with the terminal device, and the plurality of TPFs are in one-to-one correspondence with the plurality of tasks, the first data includes identification information of a first task, and the first task is one of the plurality of tasks. That the access network device sends the first data to the TPF based on the first data bearer includes: The access network device sends the first data to a first TPF based on the first data bearer and the identification information of the first task, where the first TPF is a TPF corresponding to the first task.

Specifically, in the scenario in which there are a plurality of TPFs, the plurality of TPFs share a same data bearer to perform transmission of data. In this case, based on the first data bearer, the access network device learns that data is to be forwarded to a TPF, but does not know the specific TPF in the plurality of TPFs to which the data is to be forwarded. Further, the identification information of the first task is carried in the first data, so that the access network device can learn of a specific TPF to which data is to be forwarded, thereby improving communication efficiency.

Specifically, the identification information of the first task may be carried in a service data adaptation protocol (SDAP) layer, a packet data convergence protocol (PDCP) layer, a radio link control (RLC) layer, a task resource scheduling (TRS) layer, or the like of the first data. This is not limited in this application.

In some embodiments, when a plurality of task control functions (TCFs) control the plurality of TPFs to exchange the data of the plurality of tasks with the terminal device, and the plurality of TPFs are in one-to-one correspondence with the plurality of tasks, the first data further includes identification information of a first TCF, and the first TCF is configured to control the first TPF to exchange data of the first task with the terminal device. That the access network device sends the first data to the TPF based on the first data bearer includes: The access network device sends the first data to the first TPF based on the first data bearer, the identification information of the first task, and the identification information of the first TCF.

Specifically, the identification information of the first TCF may be carried in the SDAP layer, the PDCP layer, the RLC layer, the TRS layer, or the like of the first data. This is not limited in this application.

When the plurality of TCFs deploy the plurality of tasks for the plurality of TPFs and UEs, different TCFs may allocate identification information of a same task. Therefore, different TPFs need to be further distinguished by using identification information of the TCFs deploying the tasks, so that the access network device learns of a specific TPF to which data is to be forwarded, thereby improving communication efficiency.

In some embodiments, when a plurality of TPFs exchange data of a first task with the terminal device, the first data includes identification information of a first task session, the first task session is used by the terminal device to exchange the data of the first task with a first TPF, and the first TPF belongs to one of the plurality of TPFs. That the access network device sends the first data to the TPF based on the first data bearer includes: The access network device sends the first data to the first TPF based on the first data bearer and the identification information of the first task session.

Specifically, the plurality of TPFs separately establish task sessions with the terminal device. When one or more TCFs deploy one task for the plurality of TPFs, different TPFs cannot be distinguished by using identification information of the task. Therefore, the identification information of the first task may be replaced with the identification information of the first task session, or the identification information of the first task and the identification information of the first TCF may be replaced with the identification information of the first task session, so that the access network device learns of a specific TPF to which data is to be forwarded, thereby improving communication efficiency.

In some embodiments, when the first data bearer is a DRB, the first data includes second information, and the second information indicates that the first data is data of a task session. The method further includes: The access network device sends the first data to the TPF based on the second information, or the access network device sends, to the TPF based on the second information, the first data that does not carry the second information.

Specifically, “when the first data bearer is a DRB” may be understood as that the access network device does not newly define a data bearer used for transmission of data between the terminal device and the TPF, or may be understood as that the first data bearer is an existing DRB used for transmission of data between the terminal device and a UPF.

According to the foregoing method, the access network device can learn, based on the indication information carried in the first data, that data is to be forwarded to a TPF, thereby improving communication efficiency.

In some embodiments, when a plurality of TPFs exchange data of a plurality of tasks with the terminal device, and the plurality of TPFs are in one-to-one correspondence with the plurality of tasks, the first data further includes identification information of a first task, and the first task belongs to one of the plurality of tasks. That the access network device sends the first data to the TPF based on the second information includes: The access network device sends the first data to a first TPF based on the second information and the identification information of the first task, where the first TPF is a TPF corresponding to the first task.

Specifically, in the scenario in which there are a plurality of TPFs, the plurality of TPFs share a same data bearer to perform transmission of data, and the shared data bearer may be considered as an existing DRB used for transmission of data between the terminal device and a UPF. In this case, the access network device learns, based on the second information, that data is to be forwarded to a TPF. Further, the identification information of the first task is carried in the first data, so that the access network device can learn of the specific TPF to which the data is to be forwarded, thereby improving communication efficiency.

Specifically, the identification information of the first task may be carried in the SDAP layer, the PDCP layer, the RLC layer, the TRS layer, or the like of the first data. This is not limited in this application.

In some embodiments, when a plurality of TCFs control a plurality of TPFs to exchange data of a plurality of tasks with a terminal device, and the plurality of TPFs are in one-to-one correspondence with the plurality of tasks, the first data further includes identification information of a first TCF, and the first TCF is configured to control the first TPF to exchange data of the first task with the terminal device. That the access network device sends the first data to the TPF based on the second information includes: The access network device sends the first data to the first TPF based on the second information, the identification information of the first task, and the identification information of the first TCF.

Specifically, the identification information of the first TCF may be carried in the SDAP layer, the PDCP layer, the RLC layer, the TRS layer, or the like of the first data. This is not limited in this application.

When the plurality of TCFs deploy the plurality of tasks for the plurality of TPFs and UEs, different TCFs may allocate identification information of a same task. Therefore, different TPFs need to be further distinguished by using identification information of the TCFs deploying the tasks, so that the access network device learns of a specific TPF to which data is to be forwarded, thereby improving communication efficiency.

In some embodiments, when a plurality of TPFs exchange data of a first task with the terminal device, the first data further includes identification information of a first task session, the first task session is used by the terminal device to exchange the data of the first task with a first TPF, and the first TPF belongs to one of the plurality of TPFs. That the access network device sends the first data to the TPF based on the second information includes: The access network device sends the first data to the first TPF based on the second information and the identification information of the first task session.

Specifically, the plurality of TPFs separately establish task sessions with the terminal device. When one or more TCFs deploy one task for the plurality of TPFs, different TPFs cannot be distinguished by using identification information of the task. Therefore, the identification information of the first task may be replaced with the identification information of the first task session, or the identification information of the first task and the identification information of the first TCF may be replaced with the identification information of the first task session, so that the access network device learns of a specific TPF to which data is to be forwarded, thereby improving communication efficiency.

In some embodiments, the method further includes: The access network device receives third information, where the third information includes at least one of the following information:
identification information of at least one task, identification information of at least one task session, or identification information of at least one TCF, where each item of information included in the third information corresponds to at least one TPF. The access network device sends the first data to the first TPF based on the third information.

Specifically, the foregoing “each item of information included in the third information corresponds to at least one TPF” may be understood as that each item of information included in the third information may be mapped to at least one TPF.

For example, the identification information of the first task included in the third information corresponds to an IP address and a TEID of the first TPF. The access network device finds, based on the identification information of the first task carried in the first data, the IP address and the TEID of the first TPF corresponding to the first task. Further, the access network device may encapsulate the IP address and the TEID of the first TPF in the first data, and forward the first data to the first TPF.

For another example, the identification information of the first task included in the third information corresponds to the IP address and the TEID of the first TPF and an IP address and a TEID of the second TPF, and the identification information of the first TCF included in the third information corresponds to the IP address and the TEID of the first TPF. The access network device finds, based on the identification information of the first task carried in the first data, the IP address and the TEID of the first TPF and the IP address and the TEID of the second TPF that correspond to the first task. Further, the access network device finds, based on the identification information of the first TCF carried in the first data, the IP address of the first TPF corresponding to the first task. Further, the access network device may encapsulate the IP address and the TEID of the first TPF into the first data, and forward the first data to the first TPF.

For still another example, the identification information of the first task session included in the third information corresponds to the IP address and the TEID of the first TPF. The access network device finds, based on the identification information of the first task session carried in the first data, the IP address and the TEID of the first TPF corresponding to the first task session. Further, the access network device may encapsulate the IP address and the TEID of the first TPF in the first data, and forward the first data to the first TPF.

Specifically, the third information may be sent by a core network side to the access network device.

According to the foregoing method, the access network device is enabled to learn of a specific TPF to which data is to be forwarded, thereby improving communication efficiency.

According to a second aspect, a data transmission method is provided. The method may be performed by a terminal device, or may be performed by a chip or a circuit disposed in the terminal device. This is not limited in this application.

The method includes: A terminal device determines a first data bearer; and the terminal device sends first data to an access network device on the first data bearer, where the first data bearer or the first data is used by the access network device to determine to send the first data to a TPF, and the TPF is configured to exchange data of a task with the terminal device.

The task includes a process of implementing a service objective based on collaboration of heterogeneous resources.

The heterogeneous resource may be understood as a resource including at least one of computing, intelligence, data, and sensing.

The service objective may include at least one of services such as computing, data, trustworthiness, intelligence, and sensing.

Specifically, the access network device may be any device that has a function of providing access to a communication network for authorized users in a specific region. This is not limited in this application. For example, the access network device may be a gNB in a 5G network, or may have a hierarchical RAN architecture including an sNode and a cNode in a 6G network.

According to the foregoing method, the access network device can learn of data that needs to be forwarded to the TPF, thereby improving communication efficiency.

In some embodiments, the foregoing method further includes: The terminal device receives first information from the access network device, where the first information indicates that the first data bearer is used for transmission of data between the terminal device and the TPF.

Specifically, the first data bearer may be a data bearer newly defined by the access network device. For example, if 10 data radio bearers (DRBs) are currently established, the access network device may define at least one DRB in the 10 DRBs as the first data bearer, and indicate the first data bearer to the terminal device.

Specifically, the foregoing method is applicable to a scenario in which there is one TPF, and is also applicable to a scenario in which there are a plurality of TPFs. The plurality of TPFs in the scenario in which there are a plurality of TPFs respectively perform transmission of data by using different data bearers. For example, the terminal device exchanges data of a task with a TPF #1, and the first data bearer is used for transmission of data between the terminal device and the TPF #1. Alternatively, the terminal device exchanges data of a task #1 with a TPF #1, the terminal device exchanges data of a task #2 with a TPF #2, and the terminal device exchanges data of a task #3 with a TPF #3, where the first data bearer includes a data bearer #1, a data bearer #2, and a data bearer #3, the data bearer #1 is used for transmission of data between the terminal device and the TPF #1, the data bearer #2 is used for transmission of data between the terminal device and the TPF #2, and the data bearer #3 is used for transmission of data between the terminal device and the TPF #3.

According to the foregoing method, based on a bearer for receiving data, the access network device can learn that data is to be forwarded to a TPF and learn of the specific TPF to which the data is to be forwarded, thereby improving communication efficiency.

In some embodiments, when a plurality of TPFs exchange data of a plurality of tasks with the terminal device, and the plurality of TPFs are in one-to-one correspondence with the plurality of tasks, the first data includes identification information of a first task, and the first task is one of the plurality of tasks.

Specifically, in the scenario in which there are a plurality of TPFs, the plurality of TPFs share a same data bearer to perform transmission of data. In this case, based on the first data bearer, the access network device learns that data is to be forwarded to a TPF, but does not know the specific TPF in the plurality of TPFs to which the data is to be forwarded. Further, the terminal device carries the identification information of the first task in the first data, so that the access network device can learn of a specific TPF to which data is to be forwarded, thereby improving communication efficiency.

Specifically, the terminal device may include the identification information of the first task in an SDAP layer, a PDCP layer, an RLC layer, a TRS layer, or the like of the first data. This is not limited in this application.

In some embodiments, when a plurality of TCFs control a plurality of TPFs to exchange data of a plurality of tasks with the terminal device, and the plurality of TPFs are in one-to-one correspondence with the plurality of tasks, the first data further includes identification information of a first TCF, and the first TCF is configured to control the first TPF to exchange data of the first task with the terminal device.

Specifically, the terminal device may include the identification information of the first TCF in the SDAP layer, the PDCP layer, the RLC layer, the TRS layer, or the like of the first data. This is not limited in this application.

When the plurality of TCFs deploy the plurality of tasks for the plurality of TPFs and UEs, different TCFs may allocate identification information of a same task. Therefore, the terminal device needs to further report the identification information of the TCFs deploying the tasks to distinguish between different TPFs, so that the access network device learns of a specific TPF to which data is to be forwarded, thereby improving communication efficiency.

In some embodiments, when a plurality of TPFs exchange data of a first task with the terminal device, the first data includes identification information of a first task session, the first task session is used by the terminal device to communicate with the first TPF based on the first task, and the first TPF is one of the plurality of TPFs.

Specifically, the plurality of TPFs separately establish task sessions with the terminal device. When one or more TCFs deploy one task for the plurality of TPFs, different TPFs cannot be distinguished by using identification information of the task. Therefore, the terminal device may replace the identification information of the first task with the identification information of the first task session, or the terminal device may replace the identification information of the first task and the identification information of the first TCF with the identification information of the first task session, so that the access network device learns of a specific TPF to which data is to be forwarded, thereby improving communication efficiency.

In some embodiments, when the first data bearer is a DRB, the first data includes second information, and the second information indicates that the first data is data of a task session.

Specifically, “when the first data bearer is a DRB” may be understood as that the access network device does not newly define a data bearer used for transmission of data between the terminal device and the TPF, or may be understood as that the first data bearer is an existing DRB used for transmission of data between the terminal device and a UPF.

According to the foregoing method, the access network device can learn, based on the indication information carried in the first data, that data is to be forwarded to a TPF, thereby improving communication efficiency.

In some embodiments, when a plurality of TPFs exchange data of a plurality of tasks with the terminal device, and the plurality of TPFs are in one-to-one correspondence with the plurality of tasks, the first data further includes identification information of a first task, and the first task is one of the plurality of tasks.

Specifically, in the scenario in which there are a plurality of TPFs, the plurality of TPFs share a same data bearer to perform transmission of data, and the shared data bearer may be considered as an existing DRB used for transmission of data between the terminal device and a UPF. In this case, the access network device learns, based on the second information reported by the terminal device, that data is to be forwarded to a TPF. Further, the identification information of the first task is carried in the first data, so that the access network device can learn of the specific TPF to which the data is to be forwarded, thereby improving communication efficiency.

Specifically, the terminal device may include the identification information of the first task in the SDAP layer, the PDCP layer, the RLC layer, the TRS layer, or the like of the first data. This is not limited in this application.

In some embodiments, when a plurality of TCFs control a plurality of TPFs to exchange data of a plurality of tasks with the terminal device, and the plurality of TPFs are in one-to-one correspondence with the plurality of tasks, the first data further includes identification information of a first TCF, and the first TCF is a TCF that controls the first TPF to communicate with the terminal device based on the first task.

Specifically, the terminal device may include the identification information of the first TCF in the SDAP layer, the PDCP layer, the RLC layer, the TRS layer, or the like of the first data. This is not limited in this application.

When the plurality of TCFs deploy the plurality of tasks for the plurality of TPFs and UEs, different TCFs may allocate identification information of a same task. Therefore, the terminal device needs to further report the identification information of the TCFs deploying the tasks to distinguish between different TPFs, so that the access network device learns of a specific TPF to which data is to be forwarded, thereby improving communication efficiency.

In some embodiments, when a plurality of TPFs exchange data of a first task with the terminal device, the first data further includes identification information of a first task session, the first task session is used by the terminal device to exchange the data of the first task with a first TPF, and the first TPF belongs to one of the plurality of TPFs.

Specifically, the plurality of TPFs separately establish task sessions with the terminal device. When one or more TCFs deploy one task for the plurality of TPFs, different TPFs cannot be distinguished by using identification information of the task. Therefore, the terminal device may replace the identification information of the first task with the identification information of the first task session, or the terminal device may replace the identification information of the first task and the identification information of the first TCF with the identification information of the first task session, so that the access network device learns of a specific TPF to which data is to be forwarded, thereby improving communication efficiency.

According to a third aspect, a data transmission apparatus is provided. The apparatus includes: a transceiver unit, configured to receive first data that is from a terminal device on a first data bearer. The apparatus further includes: a processing unit, configured to determine, based on the first data bearer or the first data, to send the first data to a TPF. The transceiver unit is further configured to send the first data to the TPF based on the first data bearer or the first data.

In some embodiments, the transceiver unit is further configured to send first information to the terminal device, where the first information indicates the first data bearer, and the first data bearer is used for transmission of data between the terminal device and the TPF. The transceiver unit is further configured to send the first data to the TPF based on the first data bearer.

In some embodiments, when a plurality of TPFs communicate with the terminal device based on a plurality of tasks, and the plurality of TPFs are in one-to-one correspondence with the plurality of tasks, the first data includes identification information of a first task, the first task belongs to one of the plurality of tasks. That the transceiver unit is configured to send the first data to the TPF based on the first data bearer includes: The transceiver unit sends the first data to a first TPF based on the first data bearer and the identification information of the first task, where the first TPF is a TPF corresponding to the first task.

In some embodiments, when a plurality of TCFs control the plurality of TPFs to communicate with the terminal device based on the plurality of tasks, and the plurality of TPFs are in one-to-one correspondence with the plurality of tasks, the first data further includes identification information of a first TCF, and the first TCF is a TCF that controls the first TPF to communicate with the terminal device based on the first task. That the transceiver unit is configured to send the first data to the TPF based on the first data bearer includes: The transceiver unit is further configured to send the first data to the first TPF based on the first data bearer, the identification information of the first task, and the identification information of the first TCF.

In some embodiments, when a plurality of TPFs communicate with the terminal device based on a first task, the first data includes identification information of a first task session, the first task session is used by the terminal device to communicate with a first TPF based on the first task, and the first TPF belongs to one of the plurality of TPFs. That the transceiver unit is configured to send the first data to the TPF based on the first data bearer includes: The transceiver unit is configured to send the first data to the first TPF based on the first data bearer and the identification information of the first task session.

In some embodiments, when the first data bearer is a DRB, the first data includes second information, the second information indicates that the first data is data of a task session, and the transceiver unit is further configured to send the first data to the TPF based on the second information.

In some embodiments, when a plurality of TPFs communicate with the terminal device based on a plurality of tasks, and the plurality of TPFs are in one-to-one correspondence with the plurality of tasks, the first data further includes identification information of a first task, and the first task belongs to one of the plurality of tasks. That the transceiver unit is configured to send the first data to the TPF based on the second information includes: The transceiver unit is further configured to send the first data to a first TPF based on the second information and the identification information of the first task, where the first TPF is a TPF corresponding to the first task.

In some embodiments, when a plurality of TCFs control a plurality of TPFs to communicate with the terminal device based on a plurality of tasks, and the plurality of TPFs are in one-to-one correspondence with the plurality of tasks, the first data further includes identification information of a first TCF, and the first TCF is a TCF that controls the first TPF to communicate with the terminal device based on the first task. That the transceiver unit is configured to send the first data to the TPF based on the second information includes: The transceiver unit is configured to send the first data to the first TPF based on the second information, the identification information of the first task, and the identification information of the first TCF.

In some embodiments, when a plurality of TPFs communicate with the terminal device based on a first task, the first data further includes identification information of a first task session, the first task session is used by the terminal device to communicate with a first TPF based on the first task, and the first TPF belongs to one of the plurality of TPFs. That the transceiver unit is configured to send the first data to the TPF based on the second information includes: The transceiver unit is configured to send the first data to the first TPF based on the second information and the identification information of the first task session.

In some embodiments, the transceiver unit is further configured to receive third information, where the third information includes at least one of the following information:
identification information of at least one task, identification information of at least one task session, or identification information of at least one TCF, where each item of information included in the third information is in one-to-one correspondence. The transceiver unit is further configured to send the first data to the first TPF based on the third information.

For explanations and beneficial effects of related content of the data transmission apparatus provided in the third aspect, refer to the data transmission method shown in the first aspect. Details are not described herein again.

According to a fourth aspect, a data transmission apparatus is provided. The apparatus includes: a processing unit, configured to determine a first data bearer. The apparatus further includes: a transceiver unit, configured to send first data to an access network device on the first data bearer, where the first data bearer or the first data is used by the access network device to determine to send the first data to a TPF, and the TPF is configured to communicate with a terminal device based on a task.

In some embodiments, the transceiver unit is further configured to receive first information from the access network device, where the first information indicates the first data bearer, and the first data bearer is used for transmission of data between the terminal device and the TPF.

In some embodiments, when a plurality of TPFs communicate with the terminal device based on a plurality of tasks, and the plurality of TPFs are in one-to-one correspondence with the plurality of tasks, the first data includes identification information of a first task, and the first task belongs to one of the plurality of tasks.

In some embodiments, when a plurality of TCFs control a plurality of TPFs to communicate with the terminal device based on a plurality of tasks, and the plurality of TPFs are in one-to-one correspondence with the plurality of tasks, the first data further includes identification information of a first TCF, and the first TCF is a TCF that controls the first TPF to communicate with the terminal device based on the first task.

In some embodiments, when a plurality of TPFs communicate with the terminal device based on a first task, the first data includes identification information of a first task session, the first task session is used by the terminal device to communicate with a first TPF based on the first task, and the first TPF belongs to one of the plurality of TPFs.

In some embodiments, when the first data bearer is a DRB, the first data includes second information, and the second information indicates that the first data is data of a task session.

In some embodiments, when a plurality of TPFs communicate with the terminal device based on a plurality of tasks, and the plurality of TPFs are in one-to-one correspondence with the plurality of tasks, the first data further includes identification information of a first task, and the first task belongs to one of the plurality of tasks.

In some embodiments, when a plurality of TCFs control a plurality of TPFs to communicate with the terminal device based on a plurality of tasks, and the plurality of TPFs are in one-to-one correspondence with the plurality of tasks, the first data further includes identification information of a first TCF, and the first TCF is a TCF that controls the first TPF to communicate with the terminal device based on the first task.

In some embodiments, when a plurality of TPFs communicate with the terminal device based on a first task, the first data further includes identification information of a first task session, the first task session is used by the terminal device to communicate with a first TPF based on the first task, and the first TPF belongs to one of the plurality of TPFs.

For explanations and beneficial effects of related content of the data transmission apparatus provided in the fourth aspect, refer to the data transmission method shown in the first aspect. Details are not described herein again.

According to a fifth aspect, this application provides a processor, configured to perform the methods according to the foregoing aspects.

Operations such as sending and obtaining/receiving related to the processor may be understood as operations such as output and receiving or input of the processor, or operations such as sending and receiving performed by a radio frequency circuit and an antenna, unless otherwise specified, or provided that the operations do not contradict actual functions or internal logic of the operations in related descriptions. This is not limited in this application.

According to a sixth aspect, this application provides a communication apparatus. The apparatus includes: a memory, configured to store a program; and at least one processor, configured to execute a computer program or instructions stored in the memory, to perform the method provided in any one of the foregoing aspects or the implementations of the foregoing aspects.

According to a seventh aspect, this application provides a computer-readable storage medium. The computer-readable medium stores program code to be executed by a device, and the program code includes the method provided in any one of the foregoing aspects or the implementations of the foregoing aspects.

According to an eighth aspect, this application provides a computer program product including instructions. When the computer program product runs on a computer, the computer is enabled to perform the method provided in any one of the foregoing aspects or the implementations of the foregoing aspects.

According to a ninth aspect, this application provides a chip. The chip includes a processor and a communication interface. The processor reads, through the communication interface, instructions stored in a memory, to perform the method provided in any one of the foregoing aspects or the implementations of the foregoing aspects.

In an embodiment, the chip further includes the memory. The memory stores a computer program or the instructions. The processor is configured to execute the computer program or the instructions stored in the memory. When the computer program or the instructions are executed, the processor is configured to perform the method provided in any one of the foregoing aspects or the implementations of the foregoing aspects.

### BRIEF DESCRIPTION OF DRAWINGS

FIG. 1 is a diagram of an architecture of a communication system applicable to an embodiment of this application;

FIG. 2 is a diagram of an application architecture of a communication system applicable to an embodiment of this application;

FIG. 3 is a diagram of an architecture of a core network applicable to an embodiment of this application;

FIG. 4 shows an architecture of a protocol stack applicable to an embodiment of this application;

FIG. 5 is a diagram of a data transmission method 500 according to an embodiment of this application;

FIG. 6 is a diagram of a method 600 for establishing a task session according to an embodiment of this application;

FIG. 7 is a diagram of a data transmission method 700 according to an embodiment of this application;

FIG. 8 is a diagram of a data transmission method 800 according to an embodiment of this application;

FIG. 9 is a diagram of a data transmission method 900 according to an embodiment of this application;

FIG. 10 is a diagram of a communication apparatus 1000 according to an embodiment of this application; and

FIG. 11 is a diagram of a communication apparatus 1100 according to an embodiment of this application.

### DESCRIPTION OF EMBODIMENTS

The following describes technical solutions of this application with reference to the accompanying drawings.

The technical solutions provided in this application may be applied to various communication systems, for example, a 5th generation (5G) or a new radio (NR) system, a long term evolution (LTE) system, an LTE frequency division duplex (FDD) system, and an LTE time division duplex (TDD) system. The technical solutions provided in this application may also be applied to a future communication system, for example, a 6th generation (6G) mobile communication system. The technical solutions provided in this application may also be applied to device to device (D2D) communication, vehicle-to-everything (V2X) communication, machine to machine (M2M) communication, machine type communication (MTC), an internet of things (IoT) communication system, or another communication system.

A communication system applicable to this application is first briefly described below.

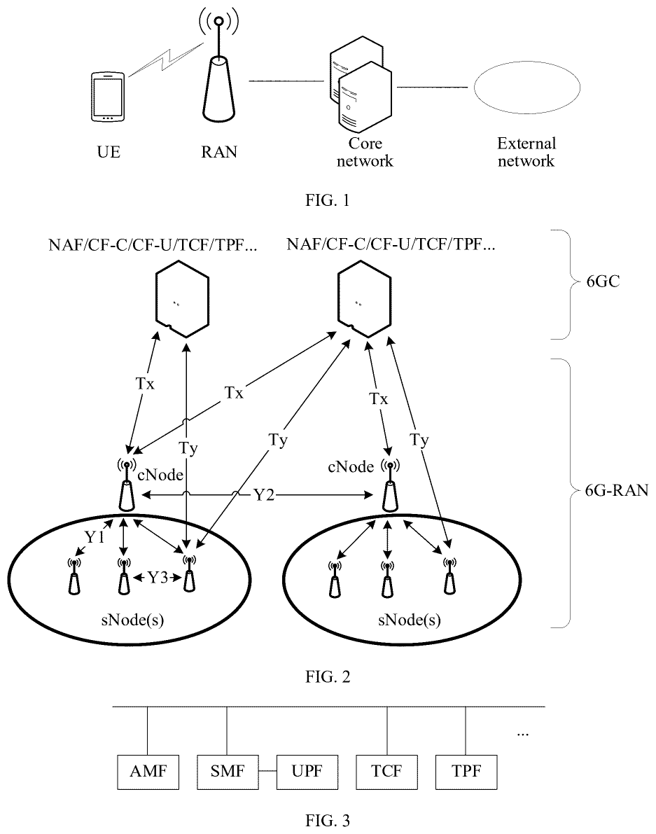

In an example, FIG. 1 is a diagram of an architecture of a communication system. For example, the architecture may include a terminal device (UE), a radio access network (RAN), a core network (CN), an external network, and the like. The external network may be a data network (DN). The RAN is a RAN provided in this application, or is referred to as a RAN node, a RAN device, an access network device, or the like.

The terminal device in this application may be referred to as an access terminal, a subscriber unit, a subscriber station, a mobile station, a remote station, a remote terminal, a mobile device, a user terminal, a terminal, a wireless communication device, a user agent, a user apparatus, or the like.

The terminal device may be a device that provides voice/data for a user, for example, a handheld device or a vehicle-mounted device having a wireless connection function. Currently, some examples of the terminal are: a mobile phone, a tablet computer, a notebook computer, a palmtop computer, a mobile internet device (MID), a wearable device, a virtual reality (VR) device, an augmented reality (AR) device, a wireless terminal in industrial control, a wireless terminal in self driving, a wireless terminal in a remote medical surgery, a wireless terminal in a smart grid, a wireless terminal in transportation safety, a wireless terminal in a smart city, a wireless terminal in a smart home, a cellular phone, a cordless phone, a session initiation protocol (SIP) phone, a wireless local loop (WLL) station, a personal digital assistant (PDA), a handheld device having a wireless communication function, a computing device or another processing device connected to a wireless modem, a wearable device, a terminal device in a 5G network, a terminal device in a future evolved public land mobile communication network (PLMN), or the like. This is not limited in embodiments of this application.

By way of example and not limitation, in embodiments of this application, the terminal device may alternatively be a wearable device. The wearable device may also be referred to as a wearable intelligent device, and is a general term of a wearable device that is intelligently designed and developed for daily wear by using a wearable technology, for example, glasses, gloves, a watch, clothing, and shoes. The wearable device is a portable device that can be directly worn on a body or integrated into clothes or an accessory of a user. The wearable device is not only a hardware device, but also implements a powerful function through software support, data exchange, and cloud interaction. Generalized wearable intelligent devices include full-featured and large-size devices that can implement complete or partial functions without depending on smartphones, for example, smart watches or smart glasses, and devices that focus only on a type of application function and need to work with other devices such as smartphones, for example, various smart bracelets or smart jewelry for monitoring physical signs.

In addition, the terminal device in embodiments of this application may alternatively be a terminal device in an IoT system. An IoT is an important part of future development of information technologies, and is mainly technically characterized in that things are connected to networks by using communication technologies, to implement intelligent networks of human-machine interconnection and interconnection between things.

It should be noted that, the terminal device and the access network device may communicate with each other by using an air interface technology (for example, but not limited to an NR or an LTE technology). Terminal devices may also communicate with each other by using an air interface technology (for example, but not limited to an NR or an LTE technology).

In embodiments of this application, an apparatus configured to implement a function of the terminal device may be a terminal device, or may be an apparatus that can support the terminal device in implementing the function, for example, a chip system or a chip. The apparatus may be installed in the terminal device. In embodiments of this application, the chip system may include a chip, or may include a chip and another discrete device.

The RAN may also be referred to as a RAN node, a RAN device, an access network device, or the like. The RAN may provide authorized users in a specific region with a function of accessing to a communication network. Specifically, the RAN may include a wireless network device in a 3rd generation partnership project (3GPP) network, or may include an access point in a non-3GPP network. For ease of description, an access network (AN) device is used in the following.

The AN device may use different radio access technologies. Currently, there are two types of wireless access technologies: a 3GPP access technology (for example, a wireless access technology used in a 3rd generation (3G) system, a 4th generation (4G) system, or a 5G system) and a non-3GPP access technology. The 3GPP access technology refers to an access technology that complies with a 3GPP standard specification. For example, an access network device in the 5G system is referred to as a next generation node base station (gNB) or a RAN device. The non-3GPP access technology may include an air interface technology represented by an access point (AP) in wireless fidelity (Wi-Fi), a worldwide interoperability for microwave access (WiMAX), a code division multiple access (CDMA), and the like. The AN device may allow interconnection between the terminal device and a 3GPP core network by using the non-3GPP technology.

The AN device can be responsible for functions such as radio resource management, quality of service (QOS) management, data compression, and encryption on an air interface side. The AN device provides an access service for the terminal device, to complete forwarding of control signals and user data between the terminal device and the core network.

For example, the AN device may include, but is not limited to, a macro base station, a micro base station (also referred to as a small cell), a radio network controller (RNC), a NodeB (NB), a base station controller (BSC), a base transceiver station (BTS), a home base station (for example, a home evolved NodeB, or a home NodeB, HNB), a baseband unit (BBU), an AP in a Wi-Fi system, a radio relay node, a radio backhaul node, a transmission point (TP), or a transmission and reception point (TRP); or may be a gNB or a transmission point (TRP or TP) in a 5G (for example, NR) system, or one antenna panel or a group of antenna panels (including a plurality of antenna panels) of a base station in a 5G system; or may be a network node constituting a gNB or a transmission point, for example, a distributed unit (DU), or a base station in a next generation 6G communication system. A specific technology used by the AN device and a specific device form of the AN device are not limited in embodiments of this application.

In addition to providing a basic connection service, the AN provided in this application further needs to provide various new service capabilities such as computing, data, trustworthiness, intelligence, and sensing, to effectively enable everything as a service (XaaS) in a future communication system. Therefore, the future communication system needs to build an endogenous integrated and converged multi-dimensional heterogeneous resources (computing, artificial intelligence (AI) data, AI model, and the like), to efficiently provide the new service capabilities.

Specifically, a process of completing a specific objective at a network layer through multi-dimensional resource collaboration is defined as a “task”. In other words, a task refers to a process of completing a specific objective by collaborating heterogeneous resources such as computing, algorithm, connection, and data.

In a task centric architecture, a task anchor (TA) and a task executor (TE) are introduced. The TA and the TE use the task as a management and control object, support managing and controlling a life cycle of the task, and collaborate and schedule the computing, algorithm, connection, and data to ensure quality of service (QOS) of the task, so as to ensure smooth execution of the task.

The TA may also be understood as a control plane function, and the TE is a data processing function. The TA is used to provide a management and control function for the task. The management and control function may include being responsible for managing the life cycle of the task, completing task deployment, starting, deletion, modification, monitoring, and the like based on a requirement of the task, and regulating network resources to ensure the requirement of the task. In addition to a control function, the management and control function also has a function of selecting the control function. For example, a first TA having the management and control function may select a second TA to execute the control function of the task. The TE is responsible for executing the task and performing data exchange in service logic. A task trigger source sends a task request to the TA, and the TA deploys the task on one or more TEs for execution.

To implement the foregoing task structure, a hierarchical RAN architecture is provided, which can provide a new service more efficiently.

FIG. 2 is a diagram of a network architecture applicable to an embodiment of this application.

The network architecture is applicable to a 6G system (6GS). The network architecture includes a 6G core network (6GC) (a 6GC part shown in FIG. 2) and a hierarchical RAN architecture (a 6G-RAN part shown in FIG. 2).

In the hierarchical RAN architecture, a centralized coordinator node is introduced to provide intra-region and inter-region task coordination. For example, the RAN architecture includes a cluster control node (cNode) and a service serving node (sNode). For example, the cNode provides a region-level centralized coordination function of a plurality of sNodes, and a cross-region coordination function between cNodes. In a cluster (or in a corresponding region that the cNode can provide centralized coordination), the cNode provides an anchor function of a task. On an air interface, the cNode does not provide a connection function or provides only a connection control function (functions provided vary based on different designs of the hierarchical RAN architecture). The sNode provides a task execution function. On an air interface, the sNode provides a connection control and/or data function (functions provided vary based on different designs of the hierarchical RAN architecture).

In an embodiment, the cNode and the sNode are respectively referred to as network elements (NEs). This is not limited. If functions of the cNode and the sNode are split (a microservice architecture is used inside a base station), network functions inside the cNode and the sNode may be further defined.

For example, the cNode may be responsible for a task-based control plane function (for example, a TA) and a data processing function (for example, when the cNode has computing power), a task scheduler (TS) and a TE may also be deployed, to execute a data processing task. The sNode is responsible for a task-based user plane function (for example, a TE).

The hierarchical RAN architecture supports implementing resource coordination and service QoS assurance of a plurality of types of resources and a plurality of nodes in a form of a task. This finally brings a new dimension (evolving from a single dimension of a connection service to a new dimension of services such as connection, computing, data, intelligence, trustworthiness, algorithm, and sensing encapsulated and provided in a form of a task) to a future wireless communication network, and implements service level agreement (SLA) assurance of various services such as AI, sensing, computing, and data. Therefore, an application scenario of the wireless communication network is further expanded.

In the network architecture shown in FIG. 2, different nodes communicate with each other through interfaces.

For example, the cNode and the sNode are connected to each other through a Y1 interface, cNodes are connected to each other through a Y2 interface, and sNodes are connected to each other through a Y3 interface.

For another example, the cNode may be connected to the 6GC through a Tx interface. The cNode is connected to a network access function (NAF) through a T3 interface, is connected to a connectivity function control plane (CF-C) through a T4 interface, and is connected to a task control function (task control function, TCF)/task processing function (TPF) through a T2 interface.

For another example, the sNode may be connected to the 6GC through a Ty interface. The sNode is connected to the NAF through a T5 interface, is connected to the CF-C through a T6 interface, and is connected to a connectivity function user plane (CF-U) through a T7 interface.

It should be noted that, the UE may be connected to one or more TCFs of the 6GC, or the UE may be connected to one or more TPFs controlled by one or more TCFs of the 6GC, or the TCF of the 6GC may be connected to one or more UEs, or the TPF controlled by the TCF of the 6GC may be connected to one or more UEs. This is not limited in this application. The UE may be connected to the 6GC through the hierarchical RAN, or may be directly connected to the 6GC through non-access stratum (NAS) signaling. This is not limited in this application.

The foregoing interface names are merely an example for description, and are not limited in embodiments of this application.

It should be understood that, the foregoing names are defined only for ease of distinguishing between different functions, and should not constitute any limitation on this application. This application does not exclude a possibility of using other names in a 6G network and another future network.

For 6GC network elements such as the TCF and the TPF, refer to descriptions in FIG. 3 below.

FIG. 3 is a diagram of an architecture of a core network applicable to an embodiment of this application.

The network architecture includes, but is not limited to: a TPF, a TCF, an access and mobility management function (AMF), a session management function (SMF), and a user plane function (UPF).

The core network architecture may be applied to 6G, which is referred to as a 6G core network (6GC or 6GCN).

The following briefly describes network elements shown in FIG. 3.

1. TCF: provides a task control function and a task scheduling function on a core network side, or provides a TA function and a TS function. The TCF specifically includes task life cycle management, such as deployment, modification, and deletion of a task, management of four elements of task resources (computing, data, algorithm, and connection), and dynamic adjustment of a task configuration and scheduling of the four elements of task resources during task execution.

2. TPF: provides a task execution function on a core network side, or provides a TE function. The TPF is controlled by the TCF, executes a task deployed by the TCF, and exchanges task data with another executor. After the task is completed, a task result is output in a specified manner.

3. SMF: is mainly responsible for a session management function, completing internet protocol (IP) address assignment and management of a terminal device, selecting a UPF, terminating a policy control and charging function interface, and downlink data notification, and completing procedures related to a protocol data unit (PDU) session, such as establishment, release, and update.

4. UPF: is used as an interface to a data network, and implements functions such as user plane data forwarding, session/flow level based charging statistics collection, and bandwidth limitation, that is, packet routing and forwarding, quality of service (QOS) processing for user plane data, and the like.

5. AMF: is mainly used for mobility management, access management, and the like. The AMF mainly performs functions such as mobility management, and access authentication/authorization. In addition, the AMF is further responsible for transfer of a user policy between a terminal device and a policy control function (PCF) network element. The AMF may receive non-access stratum (NAS) signaling (including mobility management (MM) signaling, session management (SM) signaling) of the terminal device, and related signaling (for example, N2 (next generation network (NG) 2 interface) signaling at a base station granularity exchanged with the AMF) of the access network device, to complete a user registration procedure, session management signaling forwarding, and mobility management.

In the network architecture shown in FIG. 3, the network elements may communicate with each other through interfaces.

It should be understood that, the network architecture shown above is merely an example for description, and the network architecture applicable to embodiments of this application is not limited thereto. Any network architecture that can implement functions of the network elements is applicable to embodiments of this application.

It should be further understood that, the functions shown in FIG. 3 may be understood as network elements configured to implement different functions, for example, may be combined into a network slice as needed. These network elements may be independent devices, may be integrated into a same device to implement different functions, may be network elements in a hardware device, may be software functions running on dedicated hardware, or may be virtualization functions instantiated on a platform (for example, a cloud platform). Specific forms of the network elements are not limited in this application.

It should be further understood that, the foregoing names are defined only for ease of distinguishing between different functions, and should not constitute any limitation on this application. This application does not exclude a possibility of using other names in a future communication network.

This application includes communication between a UE and a RAN node, communication between RAN nodes, and communication between the RAN node and a core network element. The following describes a specific communication protocol stack in this application.

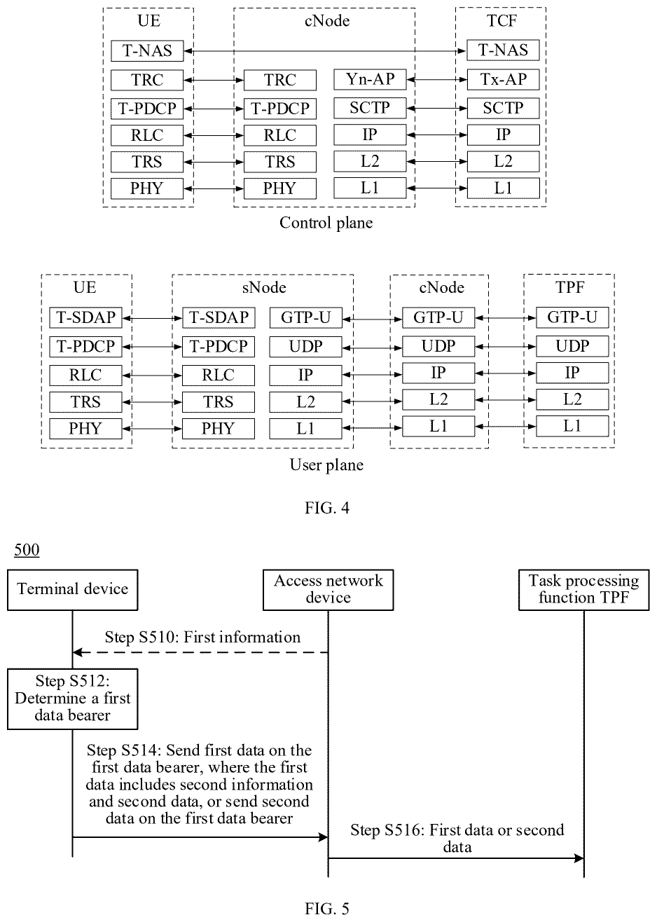

FIG. 4 shows a protocol stack architecture according to an embodiment of this application. The protocol stack includes a control plane protocol stack and a user plane protocol stack.

For example, a corresponding core network element in the control plane protocol stack is a TCF, and a corresponding core network element in the user plane protocol stack is a TPF.

A control plane performs signaling exchange. A task resource control (TRC) layer of a control plane between the UE and the RAN node may be an enhancement or evolution of a radio resource control (RRC) layer in an existing wireless communication protocol stack, and control functions such as AI, computing, and data processing of a task are added based on an existing RRC function. The TRC may be a protocol layer that includes an RRC function, or may be a protocol layer that is independent of RRC and that includes control functions such as AI, computing, and data processing of a task.

A control plane interface between RAN nodes is defined between the RAN nodes. For reliable transmission of signaling, a stream control transmission protocol (SCTP) layer is added above an internet protocol (IP) layer, and the SCTP layer provides guaranteed application layer information transmission. An application layer signaling protocol is referred to as a Yn-AP (Tx application protocol).

A control plane interface between the RAN node and the core network element TCF is defined between the RAN node and the core network element TCF. For reliable transmission of signaling, SCTP is added above the IP layer, and the SCTP layer provides guaranteed application layer information transmission. An application layer signaling protocol is referred to as a Tx/Ty-AP (Tx/Ty application protocol).

The RAN node communicates with the core network element through interfaces. For example, communication interfaces are Tx and Ty. In embodiments of this application, an interface name is not limited, and the interface may alternatively have another name.

The foregoing is merely an example for description. In embodiments of this application, an interface name is not limited, and the interface may alternatively have another name.

A user plane performs data exchange. A task resource scheduler (TRS) layer of a user plane between the UE and the RAN node may be an enhancement or evolution of a media access control (MAC) layer in an existing wireless communication protocol stack. For example, a computing power scheduling function is additionally added to an existing air interface resource scheduling function of the MAC layer.

A user plane signaling interface between the RAN nodes is defined between the RAN nodes. A transport layer is established above the IP layer, and a general packet radio system tunneling protocol for the user plane(GTP-U) is used above a user datagram protocol (UDP)/IP to carry the user plane PDU between the RAN nodes.

A user plane signaling interface between the RAN node and the core network element TCF is defined between the RAN node and the core network element TCF. The transport layer is established above the IP layer. The GTP-U is used above the UDP/IP to carry the user plane PDU between the RAN node and the core network element TCF.

The foregoing is merely an example for description. In embodiments of this application, an interface name is not limited, and the interface may alternatively have another name.

The protocol layers shown in FIG. 4 are merely examples for description. These protocol layers may be added or deleted. This is not limited in embodiments of this application.

In the 5G system, transmission of service data is performed between the UE and the UPF by establishing a session. In the 6G or future communication system, a concept of “task” is introduced. The UE and the TPF perform exchange of data of a task by using an established task session (also referred to as transmission of data of the task session). When the UE needs to send both service data to the UPF and task data to the TPF, the base station cannot learn of a specific network function to which data from the UE needs to be forwarded.

Based on this, an embodiment of this application may provide a data transmission method 500, so that the base station can determine how to forward the data from the UE, as shown in FIG. 5.

In this embodiment, an example in which a terminal device and an access network device are used as execution bodies of interaction illustration is used to illustrate the method. However, the execution bodies of the interaction illustration are not limited in this application. For example, the access network device in FIG. 5 may alternatively be a chip, a chip system, or a processor that supports a method that can be implemented by the access network device, or may be a logical module or software that can implement all or some functions of the access network device. The terminal device in FIG. 5 may alternatively be a chip, a chip system, or a processor that supports a method that can be implemented by the terminal device, or may be a logical module or software that can implement all or some functions of the terminal device.

Operation S512: The terminal device determines the first data bearer.

Specifically, the first data bearer may be a data radio bearer (DRB) used for transmission of data of a PDU session, or may be a task data radio bearer (T-DRB) used for transmission of data of a task session.

In an embodiment, before operation S512, the foregoing method 500 further includes operation S510. In operation S510, an access network device sends first information to a terminal device, where the first information indicates that a first data bearer is a T-DRB used for transmission of data of a task session. Correspondingly, the terminal device receives the first information from the access network device.

If operation S510 is executed before operation S512, the first data bearer determined by the terminal device is a T-DRB; or if operation S510 is not executed before operation S512, the first data bearer determined by the terminal device is a DRB used for transmission of data of a PDU session.

If operation S510 is executed before operation S512, the method 500 further includes operation S514. In operation S514, the terminal device sends second data on the first data bearer, where the second data is data of a task session; or if operation S510 is not executed before operation S512, the method 500 includes operation S514. In operation S514, the terminal device sends first data on the first data bearer, where the first data carries second information, and the second information indicates that the first data includes data of a task session. In other words, the first data includes the second information and the second data.

In the method 500, if the access network device receives the second data, the access network device forwards the second data to the TPF; or if the access network device receives the first data, the access network device forwards the first data or the second data to the TPF. In other words, the access network device may include or may not include the second information when performing forwarding to the TPF.

Operation S516: The access network device sends the first data or the second data to the TPF based on the first data bearer or the first data. Correspondingly, the TPF receives the first data or the second data from the access network device.

For example, if operation S510 is executed before operation S512, the access network device sends the second data to the TPF based on the first data bearer; or if operation S510 is not executed before operation S512, the access network device sends the first data or the second data to the TPF based on the second information carried in the first data. In this case, the second data may also be referred to as first data that does not carry the second information. Alternatively, if operation S510 is not executed before operation S512, and the terminal device does not carry the second information in the first data, the access network device sends the first data to the UPF.

According to the method 500, the access network device may determine how to forward data from the terminal device, so that the access network device does not retain the data from the terminal device or send the data from the terminal device by mistake, thereby improving communication efficiency. Alternatively, according to the method 500, the data of the task session and the data of the PDU session may be distinguished on a terminal device side, and indicated to the access network device, so that the access network device does not retain the data from the terminal device or send the data from the terminal device by mistake, thereby improving communication efficiency.

The following describes the technical solutions of this application in detail by using an example in which the access network device is the hierarchical RAN architecture shown in FIG. 2 and the terminal device is the UE. It should be noted that the access network device in this application may be any RAN listed above. This is not limited in this application. For example, the access network device may be the gNB in the 5G system, or may be the hierarchical RAN architecture including the cNode and the sNode in the 6G system.

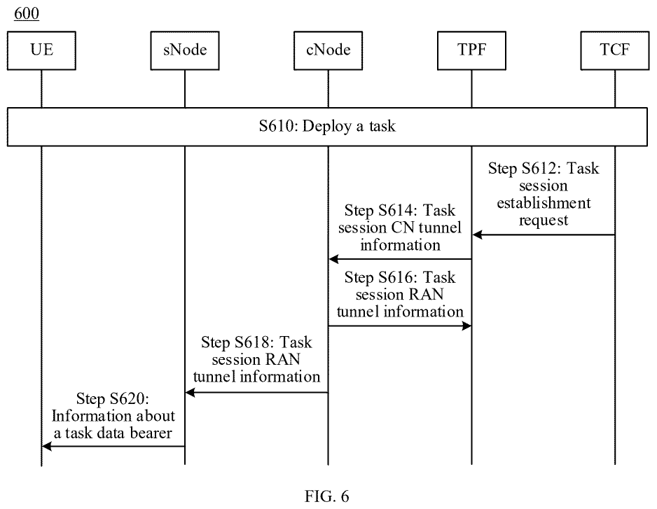

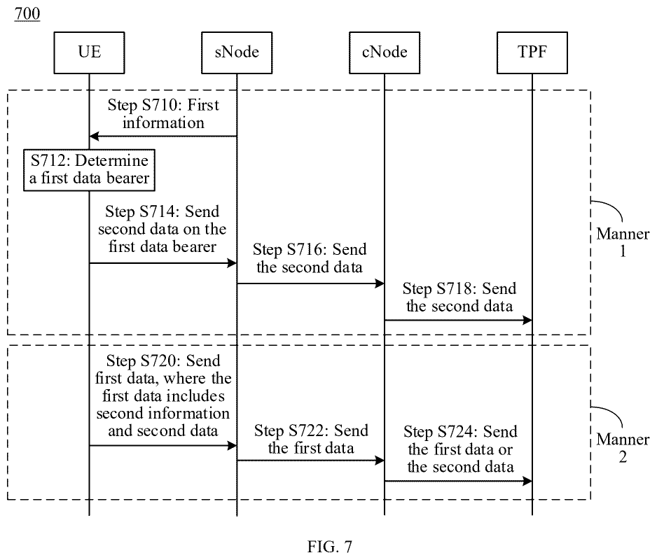

A task session needs to be established before a UE and a TPF exchange task data. In this application, a method 600 for establishing a task session between a UE and a TPF is first described, as shown in a schematic flowchart of FIG. 6.

For ease of understanding the technical solutions of this application, for example, in embodiments of this application, a session established between a UE and a UPF in a 5G system is referred to as a PDU session, and a task established between a UE and a TPF in a 6G system is referred to as a task session.

Operation S610: A TCF deploys a task for the UE and the TPF.

Specifically, as described above, a process of completing a specific objective at a network layer through multi-dimensional resource coordination is referred to as a task. The TCF that provides a task control function on a core network side is responsible for deploying the task. For example, the TCF controls a task executor TPF to execute the deployed task, and exchanges data of the task with another task executor (for example, the UE).

Because the task data needs to be exchanged between the UE and the TPF in a process of executing the task, the TCF triggers establishment of a task session between the UE and the TPF.

Operation S612: The TCF sends a task session establishment request to the TPF. Correspondingly, the TPF receives the task session establishment request from the TCF.

The task session establishment request includes location information of the UE. For example, the location information of the UE may be an IP address of a cNode connected to the UE.

In an embodiment, the task session establishment request further includes at least one of the following information:
identification information of the task (task ID), identification information of the task session (task session ID), or identification information of the TCF (TCF ID). It should be understood that, one task includes one or more task sessions. When one task includes one task session, the task may also be referred to as a task session. When one task includes a plurality of task sessions, identification information of the task corresponds to identification information of the plurality of task sessions.

Operation S614: The TPF sends task session CN tunnel information to a cNode. Correspondingly, the cNode receives the task session CN tunnel information from the TPF.

For example, the task session CN tunnel information includes information such as an IP address of the TPF and a tunnel endpoint identity (tunnel endpoint identity, TEID) of the TPF.

In an embodiment, the task session CN tunnel information further includes at least one of the following information:
identification information of the task (task ID), identification information of the task session (task session ID), identification information of the TCF (TCF ID), or the like.

Operation S616: The cNode sends task session RAN tunnel information to the TPF. Correspondingly, the TPF receives the task session RAN tunnel information from the cNode.

For example, the task session RAN tunnel information includes information such as an IP address of the cNode and a TEID of the cNode.

Optionally, the task session RAN tunnel information further includes at least one of the following information:
identification information of the task (task ID), identification information of the task session (task session ID), identification information of the TCF (TCF ID), or the like.

Operation S618: The cNode also sends the task session RAN tunnel information to an sNode. Correspondingly, the sNode receives the task session RAN tunnel information from the cNode.

Operation S620: The sNode allocates a task data bearer to the task session, and sends information about the task data bearer to the UE. Correspondingly, the UE receives the information about the task data bearer from the sNode.

Specifically, the information about the task data bearer indicates at least one DRB or at least one T-DRB.

For example, when sending the information about the task data bearer to the UE, the sNode may carry the first information in the information about the task data bearer, to indicate the at least one T-DRB.

In an embodiment, the sNode also sends information such as the identification information of the task (task ID), the identification information of the task session (task session ID), and the identification information of the TCF (TCF ID) to the UE.

According to the method 600, the task session between the UE and the TPF can be established, so that the UE and the TPF may exchange task data by using the newly established task session.

Based on the method 600, the following describes a data transmission method provided in embodiments of this application, so that a base station can determine how to forward data from the UE.

Specifically, as described above, the UE may be connected to one or more TCFs of a 6GC, or the UE may be connected to one or more TPFs controlled by one or more TCFs of a 6GC, or a TCF of a 6GC may be connected to one or more UEs, or a TPF controlled by a TCF of a 6GC may be connected to one or more UEs. Specifically, the plurality of connection manners may be mainly summarized into the following three scenarios:

Scenario 1: For one task, one TCF is deployed to one TPF and a UE for execution. In this case, the UE is connected to one TPF, and one TPF is connected to one TCF.

Scenario 2: The UE is connected to N TPFs, and the N TPFs are connected to one TCF.

The scenario 2 may further be specifically divided into two cases:
(a): For N tasks, one TCF is deployed to N TPFs and a UE for execution. One TPF corresponds to one task.
(b): For one task, one TCF is deployed to N TPFs and a UE for execution.

Scenario 3: The UE is connected to N TPFs, and the N TPFs are connected to M TCFs.

The scenario 3 may further be specifically divided into two cases:
(a): For N tasks, M TCFs are deployed to N TPFs and a UE for execution. One TPF corresponds to one task.
(b): For one task, M TCFs are deployed to N TPFs and a UE for execution.

In this application, each task in the N tasks includes a process of implementing a service objective based on collaboration of heterogeneous resources. The heterogeneous resources may include resources such as computing, intelligence, data, and sensing. The service objective may include model training, model inference, high-precision positioning, and the like.

In other words, each task in the N tasks is a task-based service provided by using a collaboration capability of multi-dimensional heterogeneous resources, for example, various new service capabilities such as computing, data, trustworthiness, intelligence, and sensing.

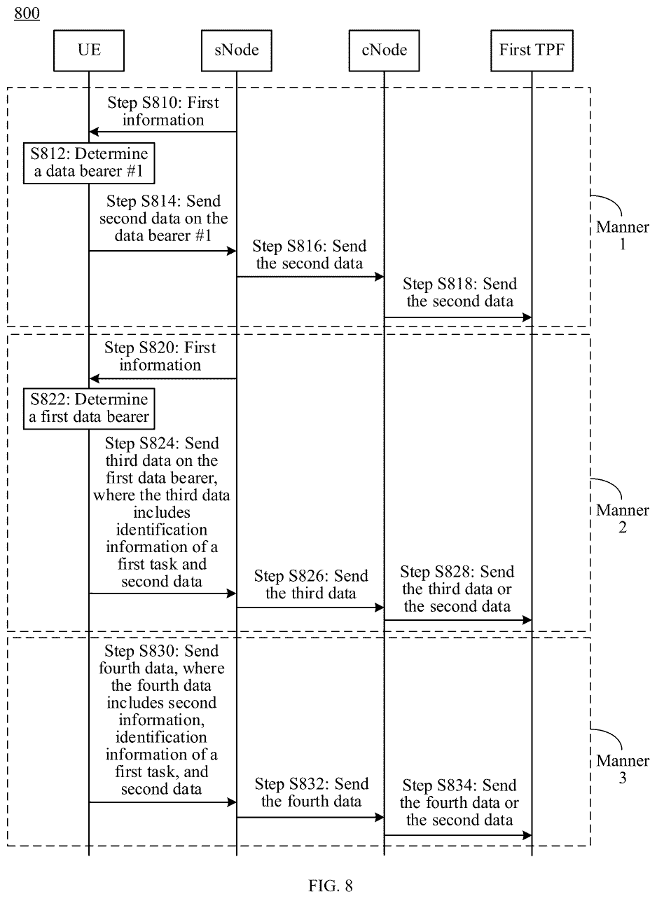

Next, FIG. 7 describes a data transmission method 700 provided in the scenario 1 in this application.

Specifically, the data transmission method 700 corresponds to two manners.

### Manner 1

Operation S710: An sNode sends first information to a UE, where the first information indicates that a first data bearer is a T-DRB. Correspondingly, the UE receives the first information from the sNode.

Operation S712: The UE determines, based on that second data whose transmission needs to be performed currently is data of a task session, that the first data bearer is the T-DRB.

Operation S714: The UE sends the second data to the sNode on the first data bearer. Correspondingly, the sNode receives the second data from the UE.

The first data bearer is the T-DRB or a DRB.

Operation S716: The sNode encapsulates a TEID corresponding to the task session into a GTP-U header of the second data, encapsulates a UDP port number into a UDP header of the second data, encapsulates an IP address of a cNode into an IP header of the second data, and the like, and sends the second data to the cNode. Correspondingly, the cNode receives the second data from the sNode.

The cNode determines, by parsing the TEID encapsulated in the GTP-U header, to forward the second data to a TPF.

Operation S718: The cNode encapsulates the TEID corresponding to the task session into the GTP-U header of the second data, encapsulates the UDP port number into the UDP header of the second data, encapsulates an IP address of the TPF into the IP header of the second data, and the like, and sends the second data to the TPF. Correspondingly, the TPF receives the second data from the cNode.

Specifically, the cNode sends the second data to the TPF based on the first data bearer.

For example, in the scenario 1, a TCF #1 may deploy a task #1 to the TPF and the UE for execution, and the TCF #1 deploys a task #2 to the TPF and the UE for execution. Therefore, data of a plurality of tasks is exchanged between one TPF and the UE. In this case, the second data sent by the UE to the sNode further includes identification information of the task #1. Specifically, the sNode sends the second data to the TPF based on the second data received on the first data bearer. Further, the TPF may learn, based on identification information of the task #1 carried in the second data, that the second data exchanged with the UE is data of the task #1, or the TPF may learn, based on identification information of the task #2 carried in the second data, that the second data exchanged with the UE is data of the task #2.

In addition, in an implementation, if operation S710 in Manner 1 is not executed, the cNode sends data to the UPF.

### Manner 2

In Manner 2, transmission of the data of the task session and the data of the PDU session is performed by using a same data bearer. For example, transmission of the data of the task session and transmission of the data of the PDU session each are performed by using a DRB.

Operation S720: The UE sends first data to an sNode on a DRB, where the first data includes second information and second data, the second information indicates that the first data includes the second data, and the second data is the data of the task session. Correspondingly, the sNode receives the first data from the UE.

For example, the UE may include fields of the second information at any one of a service data adaptation protocol (SDAP) layer, a packet data convergence protocol (PDCP) layer, a radio link control (RLC) layer, and a TRS layer of the first data. This is not limited in this application.

Operation S722: The sNode sends the first data to a cNode.

The cNode determines, by parsing the second information, to forward the first data or the second data to the TPF.

Operation S724: The cNode encapsulates the TEID corresponding to the task session into a GTP-U header of the first data or the GTP-U header of the second data, encapsulates a UDP port number into a UDP header of the first data, encapsulates an IP address of a TPF into an IP header of the first data, and the like, and sends the first data or the second data to the TPF. Correspondingly, the TPF receives the first data or the second data from the cNode.

Specifically, the cNode forwards the first data or the second data to the TPF, that is, the cNode may include or may not include the second information when performing forwarding to the TPF. It should be understood that the second data may also be referred to as first data that does not carry the second information.

Specifically, in the scenario 1, a TCF #1 may deploy a task #1 to the TPF and the UE for execution, and the TCF #1 deploys a task #2 to the TPF and the UE for execution. Therefore, data of a plurality of tasks is exchanged between one TPF and the UE. In this case, the first data sent by the UE to the sNode further includes identification information of a task. For example, the cNode sends the first data to the TPF based on the second information. Further, the TPF may learn, based on identification information of the task #1 carried in the first data, that the first data exchanged with the UE is data of the task #1, or the TPF may learn, based on identification information of the task #2 carried in the first data, that the first data exchanged with the UE is data of the task #2.

In addition, in an implementation, if the terminal device does not include the second information in the first data, the cNode sends data to the UPF.

According to the method 700, a base station may determine how to forward uplink data that is from the terminal device, thereby improving communication efficiency. The method 700 may also enable the UE to determine how to send the data of the task session to the base station, thereby improving communication efficiency.

FIG. 8 describes a data transmission method 800 provided in the scenario 2 in this application.

Specifically, the data transmission method 800 corresponding to the case (a) in the scenario 2 includes three manners.

### Manner 1

In Manner 1, the data of the task session and the data of the PDU session use different data bearers.

Operation S810: An sNode sends first information to a UE, where the first information indicates that a first data bearer is a T-DRB. Correspondingly, the UE receives the first information from the sNode.

Specifically, the first data bearer includes N data bearers, the N data bearers are N T-DRBs used for transmission of data of a task session, the N T-DRBs are in one-to-one correspondence with N task sessions, and the N task sessions are in one-to-one correspondence with N TPFs. N is a positive integer greater than 1.

Operation S812: The UE determines, based on that second data that needs to be transmitted currently is the data of the task session, that the first data bearer is the T-DBR. Further, the UE may determine that the second data that needs to be transmitted currently is data of a first task executed by the UE and a first TPF, where the first task is one of the N tasks.

Operation S814: The UE sends the second data to the sNode on a data bearer #1 corresponding to the first task. The data bearer #1 is one of the N T-DRBs. Correspondingly, the sNode receives the second data from the UE.

Operation S816: The sNode encapsulates a TEID corresponding to the task session into a GTP-U header of the second data, encapsulates a UDP port number into a UDP header of the second data, encapsulates an IP address of a cNode into an IP header of the second data, and the like, and sends the second data to the cNode. Correspondingly, the cNode receives the second data from the sNode.

Operation S818: The cNode encapsulates the TEID corresponding to the task session into the GTP-U header of the second data, encapsulates the UDP port number into the UDP header of the second data, encapsulates an IP address of the first TPF into the IP header of the second data, and the like, and sends the second data to the first TPF. Correspondingly, the first TPF receives the second data from the cNode.

Specifically, the cNode sends the second data to the first TPF based on the data bearer #1.

In addition, in an implementation, if operation S810 in Manner 1 is not executed, the cNode sends data to the UPF.

### Manner 2

In Manner 2, the data of the task session and the data of the PDU session are transmitted by using different data bearers. However, a difference from Manner 1 lies in that N different task sessions are transmitted by using a same data bearer. In other words, in Manner 1, any task session in the N task sessions corresponds to one data bearer, and the N task sessions correspond to N data bearers. In Manner 2, the N task sessions correspond to one data bearer.

Operation S820: An sNode sends first information to a UE, where the first information indicates that a first data bearer is a T-DRB. Correspondingly, the UE receives the first information from the sNode.

Operation S822: The UE determines, based on that third data that needs to be transmitted currently is the data of the task session, that the first data bearer is a T-DRB.

Operation S824: The UE sends the third data to the sNode on the first data bearer. Correspondingly, the sNode receives the third data from the UE.

Specifically, the third data sent by the UE to the sNode includes identification information of a first task. In other words, the third data includes the identification information of the first task and second data. The first task is any task in the N tasks, and the second data is data of a task session corresponding to the first task.

Operation S826: The sNode encapsulates a TEID corresponding to the task session into a GTP-U header of the third data, encapsulates a UDP port number into a UDP header of the third data, encapsulates an IP address of a cNode into an IP header of the third data, and the like, and sends the third data to the cNode. Correspondingly, the cNode receives the third data from the sNode.

Operation S828: The cNode encapsulates the TEID corresponding to the task session into the GTP-U header of the third data or the second data, encapsulates the UDP port number into the UDP header of the third data or the second data, encapsulates an IP address of a first TPF into the IP header of the third data or an IP header of the second data, and the like, and sends the third data or the second data to the first TPF. Correspondingly, the first TPF receives the third data or the second data from the cNode. It should be understood that the second data may also be referred to as third data that does not carry the identification information of the first task.

Specifically, the cNode forwards the third data or the second data to the first TPF, that is, the cNode may include or may not include the identification information of the first task when performing forwarding to the first TPF.

The cNode sends the third data or the second data to the TPF based on the first data bearer. Further, the cNode sends the third data or the second data to the first TPF in the N TPFs based on the identification information of the first task.

In addition, in an implementation, if operation S820 in Manner 2 is not executed and the terminal device does not include the identification information of the first task in the third data, the cNode sends data to the UPF.

### Manner 3

In Manner 3, the data of the task session and the data of the PDU session are transmitted by using a same data bearer. For example, transmission of data of N different task sessions and transmission of the data of the PDU session each are performed by using a DRB.

Operation S830: A UE sends fourth data to an sNode on a DRB, where the fourth data includes second information, identification information of a first task, and second data, the second information indicates that the fourth data includes the second data, the first task is any task in N tasks, and the second data is data of a task session corresponding to the first task. Correspondingly, the sNode receives the fourth data from the UE.

For example, the UE may include fields of the second information and fields of the identification information of the first task in an SDAP layer, a PDCP layer, an RLC layer, a TRS layer, or the like of the fourth data. This is not limited in this application.

Operation S832: The sNode sends the fourth data to a cNode.

The cNode determines, by parsing the second information, to forward the fourth data or the second data to a TPF. Operation S834: The cNode encapsulates a TEID corresponding to the task session into a GTP-U header of the fourth data or the second data, encapsulates a UDP port number into a UDP header of the fourth data or the second data, encapsulates an IP address of a first TPF into an IP header of the fourth data or the second data, and the like, and sends the fourth data or the second data to the first TPF. Correspondingly, the first TPF receives the fourth data or the second data from the cNode.

Specifically, the cNode forwards the fourth data or the second data to the first TPF, that is, the cNode may include or may not include the second information and the identification information of the first task when performing forwarding to the first TPF.

The cNode sends the fourth data or the second data to the TPF based on the second information. Further, the cNode sends the fourth data or the second data to the first TPF in N TPFs based on the identification information of the first task. It should be understood that the second data may also be referred to as fourth data that does not carry the identification information of the first task and the second information.

In addition, in an implementation, if the terminal device does not include the second information or the identification information of the first task in the fourth data, the cNode sends data to the UPF.

The foregoing describes three manners included in the data transmission method 800 corresponding to the case (a) in the scenario 2. The data transmission method 800 corresponding to the case (b) in the scenario 2 also includes three manners. Manner 1 corresponding to the case (b) is similar to Manner 1 corresponding to the case (a), and details are not described herein again. A difference between Manner 2 corresponding to the case (b) and Manner 2 corresponding to the case (a) lies in that: the identification information of the first task carried in the third data sent in operation S824 is replaced with identification information of a first task session. When the N TPFs and the UE execute a same task, the identification information of the first task carried in the third data sent in operation S824 cannot enable the cNode to identify a specific TPF to which the third data is to be sent. In this case, transmission of data of one task session in the task is performed between each TPF in the N TPFs and the terminal. The cNode needs to identify, by using an identifier of the task session, the specific TPF to which the third data should be sent. A difference between Manner 3 corresponding to the case (b) and Manner 3 corresponding to the case (a) lies in that: the identification information of the first task carried in the fourth data sent in operation S830 is replaced with the identification information of the first task session. When the N TPFs and the UE execute a same task, the identification information of the first task carried in the fourth data sent in operation S830 cannot enable the cNode to identify a specific TPF to which the fourth data is to be sent. Similarly, the cNode needs to identify, by using the identifier of the task session, the specific TPF to which the fourth data should be sent.

According to the method 800, when a plurality of task processing functions exist, the base station may determine how to forward the uplink data that is from the terminal device, thereby improving communication efficiency. The method 800 may also enable the UE to determine how to send the data of the task session to the base station when a plurality of task processing functions exist, thereby improving communication efficiency.

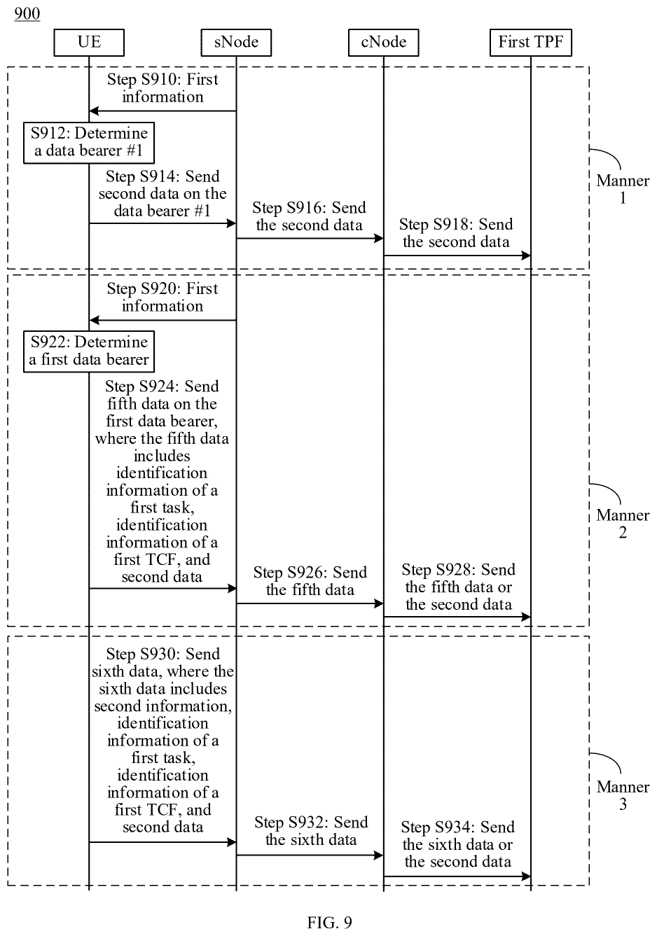

FIG. 9 describes a data transmission method 900 provided in the scenario 3 in this application.

Specifically, the data transmission method 900 corresponding to the case (a) in the scenario 3 includes three manners.

### Manner 1

In Manner 1, the data of the task session and the data of the PDU session use different data bearers.

Operation S910: An sNode sends first information to a UE, where the first information indicates that a first data bearer is a T-DRB. Correspondingly, the UE receives the first information from the sNode.

Specifically, the first data bearer includes N data bearers, the N data bearers are N T-DRBs used for transmission of data of a task session, the N T-DRBs are in one-to-one correspondence with N task sessions, and the N task sessions are in one-to-one correspondence with N TPFs. N is a positive integer greater than 1.

Operation S912: The UE determines, based on that second data that needs to be transmitted currently is the data of the task session, that the first data bearer is the T-DRB. Further, the UE may determine that the second data that needs to be transmitted currently is data in which the UE and a first TPF executes a first task, where the first task is one of the N tasks.

Operation S914: The UE sends the second data to the sNode on a data bearer #1 corresponding to the first task. The data bearer #1 is one of the N T-DRBs. Correspondingly, the sNode receives the second data from the UE.

Operation S916: The sNode encapsulates a TEID corresponding to the task session into a GTP-U header of the second data, encapsulates a UDP port number into a UDP header of the second data, encapsulates an IP address of a cNode into an IP header of the second data, and the like, and sends the second data to the cNode. Correspondingly, the cNode receives the second data from the sNode.

Operation S918: The cNode encapsulates the TEID corresponding to the task session into the GTP-U header of the second data, encapsulates the UDP port number into the UDP header of the second data, encapsulates an IP address of the first TPF into the IP header of the second data, and the like, and sends the second data to the first TPF. Correspondingly, the first TPF receives the second data from the cNode.

Specifically, the cNode sends the second data to the first TPF based on the data bearer #1.

In addition, in an implementation, if operation S910 in Manner 1 is not executed, the cNode sends data to the UPF.

### Manner 2

In Manner 2, the data of the task session and the data of the PDU session are transmitted by using different data bearers. However, a difference from Manner 1 lies in that N different task sessions are transmitted by using a same data bearer. In other words, in Manner 1, any task session in the N task sessions corresponds to one data bearer, and the N task sessions correspond to N data bearers. In Manner 2, the N task sessions correspond to one data bearer.

Operation S920: An sNode sends first information to a UE, where the first information indicates that a first data bearer is a T-DRB. Correspondingly, the UE receives the first information from the sNode.

Operation S922: The UE determines, based on that fifth data that needs to be transmitted currently is the data of the task session, that the first data bearer is a T-DRB.

Operation S924: The UE sends the fifth data to the sNode on the first data bearer. Correspondingly, the sNode receives the fifth data from the UE.

Specifically, the fifth data sent by the UE to the sNode includes identification information of a first task and identification information of a first TCF, and the first TCF is a TCF that controls the first TPF to communicate with the UE based on the first task. In other words, the fifth data includes the identification information of the first task, the identification information of the first TCF, and second data. The first task is any task in the N tasks, and the second data is data of a task session corresponding to the first task. When M TCFs deploy N tasks for the N TPFs and the UE, different TCFs may allocate identification information of a same task. Therefore, different TPFs need to be distinguished by using identification information of the TCFs deploying the tasks and identification information of the tasks.

Operation S926: The sNode encapsulates a TEID corresponding to the task session into a GTP-U header of the fifth data, encapsulates a UDP port number into a UDP header of the fifth data, encapsulates an IP address of a cNode into an IP header of the fifth data, and the like, and sends the fifth data to the cNode. Correspondingly, the cNode receives the fifth data from the sNode.

Operation S928: The cNode encapsulates the TEID corresponding to the task session into the GTP-U header of the fifth data or the second data, encapsulates the UDP port number into the UDP header of the fifth data or the second data, encapsulates an IP address of a first TPF into the IP header of the fifth data or an IP header of the second data, and sends the fifth data or the second data to the first TPF. Correspondingly, the first TPF receives the fifth data or the second data from the cNode. It should be understood that the second data may also be referred to as fifth data that does not carry the identification information of the first task or the identification information of the first TCF.

Specifically, the cNode forwards the fifth data or the second data to the first TPF, that is, the cNode may include or may not include the identification information of the first task and the identification information of the first TCF when performing forwarding to the first TPF.

The cNode sends the fifth data or the second data to the TPF based on the first data bearer. Further, the cNode sends the fifth data or the second data to the first TPF in the N TPFs based on the identification information of the first task and the identification information of the first TCF.

In addition, in an implementation, if operation S920 in Manner 2 is not executed and the terminal device does not include the identification information of the first task or the identification information of the first TCF in the fifth data, the cNode sends data to the UPF.

### Manner 3

In Manner 3, the data of the task session and the data of the PDU session are transmitted by using a same data bearer. For example, transmission of data of N different task sessions and transmission of the data of the PDU session each are performed by using a DRB.

Operation S930: A UE sends sixth data to an sNode on a DRB, where the sixth data includes second information, identification information of a first task, identification information of a first TCF, and second data, the second information indicates that the sixth data includes the second data, the first task is any task in N tasks, and the second data is data of a task session corresponding to the first task. Correspondingly, the sNode receives the sixth data from the UE.

For example, the UE may include fields of the second information, fields of the identification information of the first task, and fields of the identification information of the first TCF to an SDAP layer, a PDCP layer, an RLC layer, a TRS layer, or the like of the sixth data. This is not limited in this application.

Operation S932: The sNode sends the sixth data to a cNode.

The cNode determines, by parsing the second information, to forward the sixth data or the second data to a TPF.

Operation S934: The cNode encapsulates a TEID corresponding to the task session into a GTP-U header of the sixth data or the second data, encapsulates a UDP port number into a UDP header of the sixth data or the second data, encapsulates an IP address of a first TPF into an IP header of the sixth data or the second data, and sends the sixth data or the second data to the first TPF. Correspondingly, the first TPF receives the sixth data or the second data from the cNode.

Specifically, the cNode forwards the sixth data or the second data to the first TPF, that is, the cNode may include or may not include the second information, the identification information of the first task, and the identification information of the first TCF when performing forwarding to the first TPF. It should be understood that the second data may also be referred to as sixth data that does not carry the identification information of the first TCF, the identification information of the first task, and the second information.

The cNode sends the sixth data or the second data to the TPF based on the second information. Further, the cNode sends the sixth data or the second data to the first TPF in the N TPFs based on the identification information of the first task and the identification information of the first FCT.

In addition, in an implementation, if the terminal device does not include the second information, the identification information of the first task, and the identification information of the first TCF in the sixth data, the cNode sends data to the UPF.

The foregoing describes three manners included in the data transmission method 900 corresponding to the case (a) in the scenario 3. The data transmission method 900 corresponding to the case (b) in the scenario 3 also includes three manners. Manner 1 corresponding to the case (b) is similar to Manner 1 corresponding to the case (a), and details are not described herein again. A difference between Manner 2 corresponding to the case (b) and Manner 2 corresponding to the case (a) lies in that: the identification information of the first task and the identification information of the first TCF that are carried in the fifth data sent in operation S924 are replaced with identification information of a first task session. When the N TPFs and the UE execute a same task, the identification information of the first task and the identification information of the first TCF that are carried in the fifth data sent in operation S924 cannot enable the sNode to identify a specific TPF to which the fifth data is to be sent. In this case, transmission of data of one task session in the task is performed between each TPF in the N TPFs and the terminal. The cNode needs to identify, by using an identifier of the task session, the specific TPF to which the third data should be sent. A difference between Manner 3 corresponding to the case (b) and Manner 3 corresponding to the case (a) lies in that: the identification information of the first task and the identification information of the first TCF that are carried in the sixth data sent in operation S930 are replaced with the identification information of the first task session. When the N TPFs and the UE execute a same task, the identification information of the first task and the identification information of the first TCF that are carried in the sixth data sent in operation S930 cannot enable the sNode to identify a specific TPF to which the sixth data is to be sent. Similarly, the cNode needs to identify, by using the identifier of the task session, the specific TPF to which the fourth data should be sent.

According to the method 900, when a plurality of task processing functions and a plurality of task control functions exist, the base station may determine how to forward the uplink data that is from the terminal device, thereby improving communication efficiency. The method 900 may also enable the UE to determine how to send the data of the task session to the base station when the plurality of task processing functions and the plurality of task control functions exist, thereby improving communication efficiency. It should be understood that, sequence numbers of the foregoing processes do not mean execution sequences. The execution sequences of the processes should be determined based on functions and internal logic of the processes, and should not be construed as any limitation on implementation processes of embodiments of this application.

The foregoing mainly describes the solutions provided in embodiments of this application from a perspective of interaction between network elements. It may be understood that, to implement the foregoing functions, each network element, for example, a transmitter device or a receiver device, includes a corresponding hardware structure and/or software module for executing each function. A person skilled in the art should be aware that, units and algorithm operations in the examples described with reference to embodiments disclosed in this specification can be implemented in a form of hardware or a combination of hardware and computer software in this application. Whether a function is executed by hardware or hardware driven by computer software depends on specific applications and design constraints of the technical solutions. A person skilled in the art may use different methods to implement the described functions for each specific application, but it should not be considered that the implementation goes beyond the scope of this application.

In embodiments of this application, functional modules of the transmitter device or the receiver device may be obtained through division based on the foregoing method examples. For example, each functional module may be obtained through division based on each function, or two or more functions may be integrated into one processing module. The integrated module may be implemented in a form of hardware, or may be implemented in a form of a software functional module. It should be noted that, in embodiments of this application, module division is an example, and is merely a logical function division. During actual implementation, there may be another division manner. The following descriptions are made by using an example in which each functional module is obtained through division based on each corresponding function.

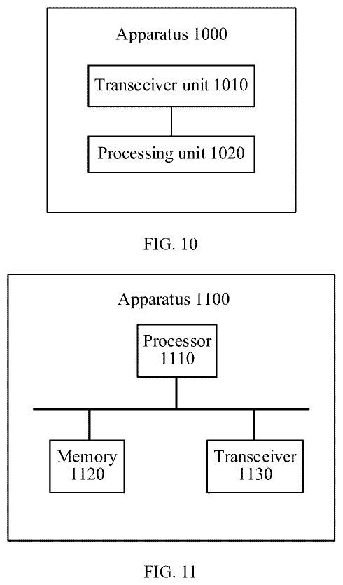

The methods provided in embodiments of this application are described above in detail with reference to FIG. 5 to FIG. 9. The apparatuses provided in embodiments of this application are described below in detail with reference to FIG. 10 and FIG. 11. It should be understood that descriptions of apparatus embodiments correspond to descriptions of method embodiments. Therefore, for content that is not described in detail, refer to the foregoing method embodiments. For brevity, details are not described herein again.

FIG. 10 is a diagram of a communication apparatus 1000 according to an embodiment of this application.

The apparatus 1000 includes a transceiver unit 1010. The transceiver unit 1010 may be configured to implement a corresponding communication function. The transceiver unit 1010 may also be referred to as a communication interface or a communication unit or an interface unit.

The apparatus 1000 may further include a processing unit 1020, and the processing unit 1020 may be configured to perform data processing.

In an embodiment, the apparatus 1000 further includes a storage unit. The storage unit may be configured to store instructions and/or data. The processing unit 1020 may read the instructions and/or the data in the storage unit, to enable the apparatus to implement actions of different devices in the foregoing method embodiments.

In a design, the apparatus 1000 is configured to execute actions executed by the access network device in the foregoing method embodiments.

Specifically, the transceiver unit 1010 is configured to receive first data that is from a terminal device on a first data bearer. The processing unit 1020 is configured to determine, based on the first data bearer or the first data, to send the first data to a TPF. The transceiver unit 1010 is further configured to send the first data to the TPF.

In a design, the apparatus 1000 is configured to execute actions executed by the terminal device in the foregoing method embodiments.

Specifically, the processing unit 1020 is configured to determine a first data bearer. The transceiver unit 1010 is configured to send first data to an access network device on the first data bearer.

The apparatus 1000 may implement operations or procedures executed by the access network device or the terminal device in the method embodiments according to embodiments of this application. The apparatus 1000 may include units configured to perform the methods performed by the terminal device, the access network device (the cNode or the sNode), or the TPF (the first TPF) in the embodiments shown in FIG. 5, FIG. 6, FIG. 7, FIG. 8, and FIG. 9.

It should be understood that specific processes of executing the foregoing corresponding operations by the units are described in detail in the foregoing method embodiments. For brevity, details are not described herein again.

It should be further understood that, the apparatus 1000 herein is embodied in a form of a functional unit. The term “unit” herein may refer to an application-specific integrated circuit (ASIC), an electronic circuit, a processor (for example, a shared processor, a dedicated processor, or a group processor) configured to execute one or more software or firmware programs, a memory, a merged logic circuit, and/or another appropriate component that supports the described functions. In an optional example, a person skilled in the art may understand that the apparatus 1000 may be specifically the access network device in the foregoing embodiments, and may be configured to execute procedures and/or operations corresponding to the access network device in the foregoing method embodiments. To avoid repetition, details are not described herein again.

The apparatus 1000 in each of the foregoing solutions has functions of implementing the corresponding operations executed by the access network device in the foregoing methods, or the apparatus 1000 in each of the foregoing solutions has functions of implementing the corresponding operations executed by the terminal device in the foregoing methods. The functions may be implemented by hardware, or may be implemented by hardware executing corresponding software. The hardware or software includes one or more modules corresponding to the functions. For example, a transceiver unit may be replaced with a transceiver (for example, a sending unit in the transceiver unit may be replaced with a transmitter, and a receiving unit in the transceiver unit may be replaced with a receiver), and another unit such as a processing unit may be replaced with a processor, to separately execute sending and receiving operations and a related processing operation in the method embodiments.

In addition, the transceiver unit 1010 may alternatively be a transceiver circuit (for example, the transceiver circuit may include a receiving circuit and a sending circuit), and the processing unit may be a processing circuit.

It should be noted that, the apparatus in FIG. 10 may be the network element or the device in the foregoing embodiments, or may be a chip or a chip system, for example, a system on chip (SoC). The transceiver unit may be an input/output circuit or a communication interface. The processing unit is a processor, a microprocessor, or an integrated circuit integrated on the chip. This is not limited herein.

FIG. 11 is a diagram of a communication apparatus 1100 according to an embodiment of this application. The apparatus 1100 includes a processor 1110. The processor 1110 is coupled to a memory 1120. The memory 1120 is configured to store a computer program or instructions and/or data. The processor 1110 is configured to execute the computer program or instructions stored in the memory 1120 or read the data stored in the memory 1120, to perform the methods in the foregoing method embodiments. As shown in FIG. 11, the apparatus 1100 further includes a transceiver 1130. The transceiver 1130 is configured to receive and/or send a signal. For example, the processor 1110 is configured to control the transceiver 1130 to receive and/or send the signal.

In an embodiment, there are one or more processors 1110.

In an embodiment, there are one or more memories 1120.

It should be understood that, the processor 1110 and the memory 1120 may be combined into one processing apparatus, and the processor 1110 is configured to execute program code stored in the memory 1120 to implement the foregoing functions. In specific implementation, the memory 1120 may be integrated into the processor 1110, or may be independent of the processor 1110. It should be understood that, the processor 1110 may correspond to each processing unit in the foregoing communication apparatus, and the transceiver 1130 may correspond to each receiving unit and sending unit in the foregoing communication apparatus.

It should be further understood that, the transceiver 1130 may include a receiver (or referred to as a receiver) and a transmitter (or referred to as a transmitter). The transceiver may further include an antenna, and a quantity of antennas may be one or more. The transceiver may alternatively be a communication interface or an interface circuit.

Specifically, the communication apparatus 1100 may correspond to the terminal device in the method 500 to the method 900 according to embodiments of this application. The communication apparatus 1100 may include units of the methods performed by the access network device in the method 500 to the method 900. It should be understood that a specific process in which the units execute the foregoing corresponding operations is described in detail in the foregoing method embodiments. For brevity, details are not described herein.

When the communication apparatus 1100 is a chip, the chip includes an interface unit and a processing unit. The interface unit may be an input/output circuit or a communication interface. The processing unit may be a processor, a microprocessor, or an integrated circuit integrated on the chip.

It should be understood that, the processor mentioned in embodiments of this application may be a central processing unit (CPU), and may further be another general-purpose processor, a digital signal processor (DSP), an application-specific integrated circuit (ASIC), a field programmable gate array (FPGA) or another programmable logic device, a discrete gate or a transistor logic device, a discrete hardware component, or the like. The general-purpose processor may be a microprocessor, or the processor may be any conventional processor, or the like.

It should be further understood that, the memory mentioned in embodiments of this application may be a volatile memory and/or a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM). For example, the RAM may be used as an external cache. By way of example and not limitation, the RAM includes the following a plurality of forms: a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct rambus random access memory (DR RAM).

It should be noted that, when the processor is a general-purpose processor, a DSP, an ASIC, an FPGA, or another programmable logic device, a discrete gate or a transistor logic device, or a discrete hardware component, a memory (a storage module) may be integrated into the processor.

It should be further noted that, the memory described in this specification is intended to include, but is not limited to, these and any other appropriate types of memories.

This application further provides a computer-readable medium. The computer-readable medium stores a computer program. When the computer program is executed by a computer, functions of any one of the foregoing method embodiments are implemented.

This application further provides a computer program product. When the computer program product is executed by a computer, functions of any one of the foregoing method embodiments are implemented.

This application further provides a system, including the foregoing access network device, TPF device, and TCF device.

All or some of the foregoing embodiments may be implemented by using software, hardware, firmware, or any combination thereof. When software is used to implement embodiments, all or some of the embodiments may be implemented in a form of a computer program product. The computer program product includes one or more computer instructions. When the computer instructions are loaded and executed on the computer, all or some of the procedures or functions according to embodiments of this application are generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from one website, computer, server, or data center to another website, computer, server, or data center in a wired (for example, a coaxial cable, an optical fiber, or a digital subscriber line (DSL)) or wireless (for example, infrared, wireless, or microwave) manner. The computer-readable storage medium may be any usable medium accessible by the computer, or a data storage device, for example, a server or a data center, integrating one or more usable media. The usable medium may be a magnetic medium (for example, a floppy disk, a hard disk, or a magnetic tape), an optical medium (for example, a high-density digital video disc (DVD)), a semiconductor medium (for example, a solid-state drive (SSD)), or the like.

In embodiments of this application, words such as “example” or “for example” are used to represent giving an example, an illustration, or a description. Any embodiment or design solution described as an “example” in this application should not be explained as being more preferred or having more advantages than another embodiment or design solution. To be precise, use of the word such as “example” is intended to present a concept in a specific manner.

It should be understood that, an “embodiment” mentioned throughout this specification means that specific features, structures, or characteristics related to the embodiment are included in at least one embodiment of this application. Therefore, embodiments in the entire specification do not necessarily refer to a same embodiment. In addition, these specific features, structures, or characteristics may be combined in one or more embodiments in any appropriate manner.

It should be understood that sequence numbers of the foregoing processes do not mean execution sequences in various embodiments of this application. The execution sequences of the processes should be determined based on functions and internal logic of the processes, and should not be construed as any limitation on the implementation processes of embodiments of this application. Names of all nodes and messages in this application are merely names set for ease of description in this application, and may be different in an actual network. It should not be understood that names of various nodes and messages are limited in this application. On the contrary, any name that has a function that is the same as or similar to that of the node or the message used in this application is considered as a method or an equivalent replacement in this application, and falls within the protection scope of this application.

It should be further understood that, in this application, “when” and “if” mean that UE or a base station performs corresponding processing in an objective situation, but do not constitute any limitation on time, do not require the UE or the base station to perform a determining action during implementation, and do not mean other limitations either.

In addition, the terms “system” and “network” may be used interchangeably in this specification. The term “and/or” in this specification describes only an association relationship for describing associated objects and represents that three relationships may exist. For example, A and/or B may represent the following three cases: Only A exists, both A and B exist, and only B exists.

The term “at least one of . . . ” in this specification represents all or any combination of the listed items. For example, “at least one of A, B, and C” may represent the following six cases:
A exists alone, B exists alone, C exists alone, A and B coexist, B and C coexist, and A, B, and C coexist. In this specification, “at least one” indicates one or more, and “a plurality of” indicates two or more.

It should be understood that, in embodiments of this application, “B corresponding to A” indicates that B is associated with A, and B may be determined based on A. However, it should be further understood that determining B based on A does not mean that B is determined based only on A. B may alternatively be determined based on A and/or other information. The terms “comprise”, “include”, “have”, and variations thereof all mean “include but is not limited to”, unless otherwise specifically emphasized in another manner.

It should be understood that, in various embodiments of this application, first, second, and various numbers are merely for differentiation for ease of description, and are not intended to limit the scope of embodiments of this application. For example, different information is differentiated.

A person of ordinary skill in the art may be aware that, units and algorithm operations in the examples described with reference to embodiments disclosed in this specification can be implemented by electronic hardware or a combination of computer software and electronic hardware. Whether the functions are executed by hardware or software depends on specific applications and design constraint conditions of the technical solutions. A person skilled in the art may use different methods to implement the described functions for each specific application, but it should not be considered that the implementation goes beyond the scope of this application.

It may be clearly understood by a person skilled in the art that, for convenient and brief description, for a detailed working process of the foregoing system, apparatus, and unit, refer to a corresponding process in the foregoing method embodiments. Details are not described herein again.

In the several embodiments provided in this application, it should be understood that the disclosed system, apparatus, and method may be implemented in another manner. For example, the described apparatus embodiments are merely examples. For example, division into the units is merely logical function division and may be other division during actual implementation. For example, a plurality of units or components may be combined or integrated into another system, or some features may be ignored or not executed. In addition, the displayed or discussed mutual couplings or direct couplings or communication connections may be implemented by using some interfaces. The indirect couplings or communication connections between the apparatuses or units may be implemented in electrical, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of embodiments.

In addition, functional units in embodiments of this application may be integrated into one processing unit, each of the units may exist alone physically, or two or more units are integrated into one unit.

When the functions are implemented in a form of a software functional unit and sold or used as an independent product, the functions may be stored in a computer-readable storage medium. Based on such an understanding, the technical solutions of this application essentially, or the part contributing to the conventional technology, or some of the technical solutions may be implemented in a form of a software product. The computer software product is stored in a storage medium, and includes several instructions for indicating a computer device (which may be a personal computer, a server, or a network device) to execute all or some of the operations of the methods described in embodiments of this application. The foregoing storage medium includes any medium that can store program code, such as a USB flash drive, a removable hard disk, a read-only memory (ROM), a random access memory (RAM), a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A data transmission method, wherein the method comprises:
receiving, by an access network device, first data from a terminal device on a first data bearer; and
sending, by the access network device, the first data to a task processing function (TPF) based on the first data bearer or the first data, wherein the TPF is configured to exchange data of a task with the terminal device.

2. The method according to claim 1, wherein the method further comprises:
sending, by the access network device, first information to the terminal device, wherein the first information indicates that the first data bearer is used for transmission of data between the terminal device and the TPF; and
sending, by the access network device, the first data to the TPF based on the first data bearer.

3. The method according to claim 2, wherein when a plurality of TPFs exchange data of a plurality of tasks with the terminal device, and the plurality of TPFs are in one-to-one correspondence with the plurality of tasks, the first data comprises identification information of a first task, and the first task belongs to one of the plurality of tasks; and
sending, by the access network device, the first data to the TPF based on the first data bearer comprises:
sending, by the access network device, the first data to a first TPF based on the first data bearer and the identification information of the first task, wherein the first TPF is a TPF corresponding to the first task.

4. The method according to claim 3, wherein when a plurality of task control functions TCFs control the plurality of TPFs to exchange the data of the plurality of tasks with the terminal device, the first data further comprises identification information of a first TCF, and the first TCF is configured to control the first TPF to exchange data of the first task with the terminal device; and
sending, by the access network device, the first data to the TPF based on the first data bearer comprises:
sending, by the access network device, the first data to the first TPF based on the first data bearer, the identification information of the first task, and the identification information of the first TCF.

5. The method according to claim 2, wherein when a plurality of TPFs exchange data of a first task with the terminal device, the first data comprises identification information of a first task session, the first task session is used by the terminal device to exchange the data of the first task with a first TPF, and the first TPF belongs to one of the plurality of TPFs; and
sending, by the access network device, the first data to the TPF based on the first data bearer comprises:
sending, by the access network device, the first data to the first TPF based on the first data bearer and the identification information of the first task session.

6. The method according to claim 1, wherein when the first data bearer is a data radio bearer DRB, the first data comprises second information, the second information indicates that the first data is data of a task session, and the method further comprises:
sending, by the access network device, the first data to the TPF based on the second information; or
sending, by the access network device to the TPF based on the second information, the first data that does not carry the second information.

7. The method according to claim 6, wherein when a plurality of TPFs exchange data of a plurality of tasks with the terminal device, and the plurality of TPFs are in one-to-one correspondence with the plurality of tasks, the first data further comprises identification information of a first task, and the first task belongs to one of the plurality of tasks; and
sending, by the access network device, the first data to the TPF based on the second information comprises:
sending, by the access network device, the first data to a first TPF based on the second information and the identification information that is of the first task, wherein the first TPF is a TPF corresponding to the first task.

8. The method according to claim 7, wherein when a plurality of task control functions TCFs control the plurality of TPFs to exchange the data of the plurality of tasks with the terminal device, the first data further comprises identification information of a first TCF, and the first TCF is configured to control the first TPF to exchange data of the first task with the terminal device; and
sending, by the access network device, the first data to the TPF based on the second information comprises:
sending, by the access network device, the first data to the first TPF based on the second information, the identification information of the first task, and the identification information of the first TCF.

9. The method according to claim 6, wherein when a plurality of TPFs exchange data of a first task with the terminal device, the first data further comprises identification information of a first task session, the first task session is used by the terminal device to exchange the data of the first task with a first TPF, and the first TPF belongs to one of the plurality of TPFs; and
sending, by the access network device, the first data to the TPF based on the second information comprises:
sending, by the access network device, the first data to the first TPF based on the second information and the identification information of the first task session.

10. The method according to claim 3, wherein the method further comprises:
receiving, by the access network device, third information, wherein the third information comprises at least one of the following information:
identification information of at least one task, identification information of at least one task session, or identification information of at least one TCF, wherein each item of information comprised in the third information corresponds to at least one TPF; and
sending, by the access network device, the first data to the first TPF based on the third information.

11. A data transmission method, wherein the method comprises:
determining, by a terminal device, a first data bearer; and
sending, by the terminal device, first data to an access network device on the first data bearer, wherein the first data bearer or the first data is used by the access network device to determine to send the first data to a task processing function (TPF), and the TPF is configured to exchange data of a task with the terminal device.

12. The method according to claim 11, wherein the method further comprises:
receiving, by the terminal device, first information from the access network device, wherein the first information indicates that the first data bearer is used for transmission of data between the

13. The method according to claim 12, wherein when a plurality of TPFs exchange data of a plurality of tasks with the terminal device, and the plurality of TPFs are in one-to-one correspondence with the plurality of tasks, the first data comprises identification information of a first task, and the first task belongs to one of the plurality of tasks.

14. The method according to claim 13, wherein when a plurality of task control functions (TCFs) control the plurality of TPFs to exchange the data of the plurality of tasks with the terminal device, the first data further comprises identification information of a first TCF, and the first TCF is configured to control a first TPF to exchange data of the first task with the terminal device.

15. The method according to claim 12, wherein when a plurality of TPFs exchange data of a first task with the terminal device, the first data comprises identification information of a first task session, the first task session is used by the terminal device to exchange the data of the first task with a first TPF, and the first TPF belongs to one of the plurality of TPFs.

16. The method according to claim 11, wherein when the first data bearer is a data radio bearer DRB, the first data comprises second information, and the second information indicates that the first data is data of a task session.

17. The method according to claim 16, wherein when a plurality of TPFs exchange data of a plurality of tasks with the terminal device, and the plurality of TPFs are in one-to-one correspondence with the plurality of tasks, the first data further comprises identification information of a first task, and the first task belongs to one of the plurality of tasks.

18. The method according to claim 17, wherein when a plurality of task control functions (TCFs) control the plurality of TPFs to exchange the data of the plurality of tasks with the terminal device, the first data further comprises identification information of a first TCF, and the first TCF is configured to control a first TPF to exchange data of the first task with the terminal device.

19. The method according to claim 16, wherein when a plurality of TPFs exchange data of a first task with the terminal device, the first data further comprises identification information of a first task session, the first task session is used by the terminal device to exchange the data of the first task with a first TPF, and the first TPF belongs to one of the plurality of TPFs.

20. A communication apparatus, comprising a processor, the processor is configured to execute programming instructions to enable the communication apparatus to:
determine a first data bearer; and
send first data to an access network device on the first data bearer, wherein the first data bearer or the first data is used by the access network device to determine to send the first data to a task processing function (TPF), and the TPF is configured to exchange data of a task with the communication apparatus.
